(19) United States
(12) Patent Application Publication
(10) Pub. No.: US 2014/0016357 A1
(43) Pub. Date: Jan. 16, 2014

(54) Power Regenerator

(71) Applicants: Yen-Wei Hsu, Taipei (TW); Whei-Chyou Wu, Fremont, CA (US)

(72) Inventors: Yen-Wei Hsu, Taipei (TW); Whei-Chyou Wu, Fremont, CA (US)

(21) Appl. No.: 13/547,060

(22) Filed: Jul. 12, 2012

(51) Int. Cl. H02M 7/00

(52) U.S. Cl. 363/13

(57) ABSTRACT

A power system comprises a switching circuit for driving an inductive load and a magnetic core coupling with the switching circuit to form a magnetic amplifier.

### FIELD OF INVENTION

This invention relates to a power regenerator, more particularly, to the power regenerator by using magnetic amplifier.

### BACKGROUND INFORMATION

Conventionally, there are a number of known voltage regulating circuits, for example, a boost circuit for boosting voltage level and a buck circuit for reducing voltage level. FIG. 1a has shown a known boost circuit.

The boost circuit of FIG. 1a has shown an electrical power source 109, an inductor 101, a switch such as a power transistor 103, a PWM controller 104 for controlling the on/off switching of the power transistor 103 and a loading 108. The electrical power source 109, the inductor 101 and the power transistor 103 are electrically connected in series with each other and the loading 108 is electrically connected to a low side of the inductor 101. It's noted that a diode 107 is for keeping current flow unidirection.

FIG. 1g has shown a prior-art blocking oscillator which can be divided into a first circuit 128 surrounded by a dotted block and a second circuit not in the first circuit electrically coupling with the first circuit 128. The second circuit formed by an electrical power source 120, a second inductor 124, a second resistor 122 which is the resistance of the second inductor 124, a transistor 125, and a driven loading 127 electrically connected to a low side of the second inductor 124. The electrical power source 120, the second inductor 124, the transistor 125 are electrically connected in series with each other.

The first circuit 128 and the second circuit are powered by the electrical power source 120. The first circuit 128 is formed by a first resistor 121, a first inductor 123 forming a transformer with the second inductor 124 as a disturbance to the blocking oscillator, and a capacitor 126 oscillates the power transistor 125 of the second circuit. The first circuit 128 and the second circuit use the same electrical power source 120 and the first circuit 128 is a RLC circuit good for oscillation and the charge or the discharge of the capacitor 126 of the first circuit 128 switch the transistor 125 so that the transistor 125 oscillated by the first circuit 128 can be viewed as a self-excitation switch and the blocking oscillator of FIG. 1g can be viewed as a self-excitation oscillator.

Both the boost circuit of FIG. 1a and the blocking oscillator of FIG. 1g respectively have a “switching circuit”. The switching circuit comprises an electrical power source for providing an electrical energy, an inductor as a load in the switching circuit for temporarily storing magnetic energy converted from the electrical energy from the electrical power source, and a switch or a frequency modulator for providing frequency-modulation to the switching circuit electrically connected in series with each other. It's noted that the on/off switching of the power transistor 109 of FIG. 1a is controlled by a “given signal” provided by the PWM controller 104, but the transistor 125 of the second circuit of FIG. 1g oscillating with the first circuit 128 can be viewed as a self-excitation switch.

The switching circuit describes converting an electrical energy of the electrical power source into a magnetic energy temporarily stored in the inductor and releasing the magnetic energy temporarily stored in the inductor into current controlled by the oscillation of the frequency modulator. By using the boost circuit of FIG. 1a as an example, when the power transistor 103 is in close state (the power transistor 103 is on), a current from the electrical power source 109 flowing through the switching circuit magnetizes the inductor 102 temporarily storing a magnetic energy converted from an electrical energy from the electrical power source 109; and when the power transistor 103 is in open state (the power transistor 103 is off), current from the electrical power source 109 stops and the magnetic energy temporarily stored in the inductor 101 will be immediately released in the form of a current for driving the loading 108. Obviously, converting the electrical energy from the electrical power source 109 into the magnetic energy stored in the inductor 101 and releasing the magnetic energy temporalily stored in the inductor 101 into current is realized by the switching of the power transistor 103. The electrical power source 109 in the switching circuit usually has a low pass filter or EMI coil for filtering high frequency current component from the electrical power source 109. For the purpose of convenience, the low pass filter of a switching circuit is called low pass filter coil in the present invention. The frequency modulator is not limited, for example, it can be a self-excitation switch as revealed in the embodiment of FIG. 1g or an electronic switch such as the transistor 103 controlled by the PWM controller 104 as shown in FIG. 1a. The electrical power source can be a dc power source such as a battery, a capacitor, a photo-electricity conversion device such as a solarcell.

A reaction circuit comprising an action/reaction isolation device and a damper of a switching circuit will be discussed in a switching circuit shown in FIG. 1b. Assuming the frequency modulator 153 of the switching circuit of FIG. 1b is a transistor, current from the electrical power source 159 will flow through the inductor 151, the transistor 153 in close state and to the ground. When the transistor 153 is turned open the current is cut off at the transistor 153 and an ac Lenz current opposite to the current from the electrical power source 159 is produced and wants to go back to the electrical power source 159. The ac Lenz current is hard to go through the inductor 151 back to the electrical power source 159 because the impedance of the inductor 151 will become higher by the high frequency excitation of the ac Lenz current so that a circuit, which is called “reaction circuit”, in parallel with the inductor 151 is for the opposite Lenz current to go through.

For any circuit, a power source applies power to a load is an “action” and when the action stops “a reaction to the action” occurs. For example, referring back to the switching circuit of FIG. 1b, when the power transistor 153 is in close state a current from the electrical power source 159 flowing through the load “the inductor” 151 is an “action” and when the transistor 153 is switched in open state the current from the electrical power source 159 is cut off at the transistor 153, the “action” stops, and an ac Lenz current, which is a reaction to the action, is expected to flow through the reaction circuit in parallel to the inductor 151. The reaction circuit comprises an action/reaction isolation device 1511 and a damper 1512 electrically connected in series. The action/reaction isolation device 1511 is used to prohibit the action, which is the current from the electrical power source 159, to flow through the reaction circuit and allow a reaction to the action, which is the Lenz current opposite to the current from the electrical power source 159 to flow through the reaction circuit. Lenz power may be a high frequency shock dangerous to the switching circuit so that the damper 1512 is needed to dissipate or stablize the Lenz power flowing through the reaction circuit.

The action/reaction isolation device 1511 is not limited, for example, the action/reaction isolation device can be an ac/dc isolation device such as a capacitor which can block the dc current from the dc power source 159 from flowing through the reaction circuit but allow the opposite ac Lenz current to go through the reaction circuit or an unidirectional device such as a diode for only allowing current to flow unidirection like as the transient voltage suppressed (TVS) diode. The diode prohibits current from the electrical power source 159 flowing through the reaction circuit but allows the opposite Lenz current to flow through the reaction circuit.

The damper 1512 is not limited. The damper 356 can be realized by a positive differential resistance device or PDR device in short and a negative differential resistance device or NDR device in short electrically connected in series. The following is a brief discussion about this.

For any RLC circuit can be expressed by two first-order differential equations as followed:

$$\{ \begin{matrix}\frac{d x}{d t} = y - F ( x ) \\ \frac{d y}{d t} = - g ( x )\end{matrix} \qquad ( 1 )$$

of which x and y are state variables of which one is current and the other one is voltage and F(x) is the impedance function. The two first-order differential equations (1) can be expressed by a secondorder differential equation as shown by:

$$\frac{{d}^{2} x}{d {t}^{2}} + \frac{d F ( x )}{d x} \frac{d x}{d t} + g ( x ) = 0$$

$$or$$

$$\frac{{d}^{2} x}{d {t}^{2}} + f ( x ) \frac{d x}{d t} + g ( x ) = 0$$

$$where$$

$$f ( x ) = \frac{d F ( x )}{d x}$$

It's noted that the

$$\frac{d F ( x )}{d x} in \frac{d x}{d t}$$

term is the damping term. According cording to the Liénard stabilized system theory, for any stabilized periodical system,

$$\frac{d F ( x )}{d x} > 0 and \frac{d F ( x )}{d x} < 0$$

hold simultaneously and the two must pass

$$\frac{d F ( x )}{d x} = 0 , where \frac{d F ( x )}{d x} > 0$$

is defined as positive differential resistance or PDR in short,

$$\frac{d F ( x )}{d x} < 0$$

is defined as negative differential resistance or NDR in short, and

$$\frac{d F ( x )}{d x} = 0$$

is a constant resistance or defined as pure resistance. Any device having PDR is a PDR device, any device having NDR is a NDR device, and any device having constant resistance is defined as pure resistor. It's obvious that current flowing through a PDR device and a NDR device electrically connected in series can satify

$$\frac{d F ( x )}{d x} > 0 and \frac{d F ( x )}{d x} < 0$$

simultaneously so that a PDR device and a NDR device electrically connected in series is a damper.

The PDR device and the NDR device are not limited, for example, a PDR device and a NDR device can respectively be a positive temperature coefficient or PTC in short and negative temperature coefficient or NTC in short. According to the chain-rule,

$$\frac{d F ( x )}{d x} = \frac{d F}{d T} \frac{d T}{d x}$$

where T is temperature and the state x is current as defined earlier, [symbol] can be interpreted as a change in current leads to a change in temperature, and the change in temperature leads to a change in resistance as described by [symbol] This explains the reason why a PTC and a NTC can respectively be the PDR device and the NDR device.

The damper 1512 and the action/reaction isolation device 1511 shown in FIG. 1b can be a PDR device 15126, a NDR device 15127 and a capacitor 15117 electrically connected in series with each other as shown in FIG. 1c, an energy discharge capacitor 15118 as shown in FIG. 1h because an energy discharge capacitor is an antion/reaction isolation device and a damper, or a PDR device 15126, a NDR device 15127 electrically connected in series and a diode 15118 electrically connected to the PDR device 15126 and the NDR device 15127 as shown in FIG. 1d. The PDR device 15126 and the NDR device 15127 shown in FIG. 1c can be a PTC 15128 and a NTC 15129 as shown in FIG. 1e. FIG. 1f has shown an embodiment that a transistor 1530 in a switching circuit is controlled by a positive on-duty multi-waveform 1535 or a negative on-duty multi-waveform 1536 respectively carrying subcarriers.

A PDR device can be a positive temperature coefficient (or PTC in short) and a NDR device can be a negative temperature coefficient (or NTC in short) or a metal oxided material such as ZnO.

A PDR device and a NDR device electrically connected in series is a damper and an energy discharge capacitor having a PDR device and a NDR device is also a damper. More detailed about both can be referred to our previous invention “a capacitor” USA early publication no. US2010-0277392A1.

An open circuit device comprises a first terminal and a second terminal separating the first terminal by an open gap having an open gap width d and an electrical discharge between the first terminal and the second terminal can take place if a voltage is applied between the first terminal and the second terminal and at least one of the first terminal and the second terminal is a discharge electrode of the electrical discharge. For the purpose of convenience, a voltage applied between a first terminal and a second terminal of an open circuit device for an occurence of an electrical discharge between the first terminal and the second terminal of the open circuit device is called “electrical discharge voltage” or “threshold voltage” in the present invention. In other words, an open circuit device has a threshold voltage for an occurence of an electrical discharge. A “threshold voltage” of an open circuit device can be obtained by a suitable design, for example, an embodiment, by adjusting the open gap width d of the open circuit device. The electrical discharge of the open circuit device is not limited, for example, it can be an electrical corona discharge or electrical glowing discharge.

FIG. 2a has shown a prior-art open circuit device 20 marked by a rectangle comprising a first terminal 201 and a second terminal 202 separating the first terminal 201 by an open gap 203 having an open gap width d. An occurence of an electrical discharge between the first terminal 201 and the second terminal 202 of the open circuit device 20 can be decided by a voltage across the first terminal 201 and the second terminal 202, the frequency of the voltage applied between the first terminal 201 and the second terminal 202, the open gap width d of the open gap 203 between the first terminal 201 and the second terminal 202, a medium disposed between the first terminal 201 and the second terminal 202, an ionization condition between the first terminal 201 and the second terminal 202, an electrical field between the first terminal 201 and the second terminal 202, temperature variation between the first terminal 201 and the second terminal 202, the shapes of the first terminal 201 and the second terminal 202, and/or the materials made of the first terminal 201 and the second terminal 202, etc. For example, an embodiment, a medium disposed in the open gap 203 can be a gas such as air or inert gas for isolating the first terminal 201 and the second terminal 202 from outside environment against oxidizing. For another example, an embodiment as shown in FIG. 2m, an energy field 29 applied through a medium 291 disposed by the open circuit device 20 to affect the conductivity and ionization between the first terminal 201 and the second terminal 202 of the open circuit device 20 can play an important role in the occurence of the electrical discharge between the first terminal 201 and the second terminal 202 so that by controlling the energy field 29 can control the occurence of the electrical discharge between the first terminal 201 and the second terminal 202 or its threshold voltage of the open circuit device 20. The energy field 29 is not limited, for example, it can be an electrical field which can affect the conductivity between the first terminal 201 and the second terminal 202 of the open circuit device 20, it can be a magnetic field which can affect the ionization between the first terminal 201 and the second terminal 202 of the open circuit device 20, or it can be a thermal field which can affect the temperature condition between the first terminal 201 and the second terminal 202 of the open circuit device 20.

The shapes of the first terminal 201 and the second terminal 202 are not limited, for example, the first terminal 201 and the second terminal 202 can be respectively shaped as needle point as shown in FIG. 2a advantaging for more precise control of an occurence of an electrical discharge and easier occurence of the an electrical discharge or shaped having an area as shown in FIG. 2b which can be viewed to be formed by a plurality of needle points featuring multiple electrical discharges between the first terminal 201 and the second terminal 202 and more precise control of occurences of multiple electrical discharges. Multiple electrical discharges between the first terminal 201 and the second terminal 202 of the open circuit device 20 shown in FIG. 2b features bigger current capability flowing between the first terminal 201 and the second terminal 202 of the open circuit device 20 at electrical discharges. For the purpose of convenience, the open circuit devices respectively of FIG. 2a and FIG. 2b are respectively called a first open circuit device and a second open circuit device in the present invention.

Needle points can be in micro or nano scale if the first terminal 201 and the second terminal 202 of an open circuit device 20 have nanoscaled materials having electrical discharges between them. Smaller scaled needle points feature higher density of needle points, higher density of electrical discharges between the first terminal 201 and the second terminal 202, bigger current capability flowing between the first terminal and the second terminal of the open circuit device and more complicated electrical discharge routes for more avoiding electrical discharges keeping at same discharge routes.

For the purpose of convenience, a plurality of microscaled or nanoscaled needle points of the first terminal 201 and the second terminal 202 of the open circuit device 20 can also be called “micro needle array” in the present invention. An inventive open circuit device having micro needle array by using nanoscaled material will be revealed by the present invention. The prior-art open circuit device is not a damper and an inventive damper based on the open circuit device or called open circuit device damper in the present invention has been also revealed in the present invention. An energy discharge capacitor having a PDR device and a NDR device is a damper. The prior-art energy discharge capacitor has a drawback that the energy discharge capacitor can only dissipate ac passing the energy discharge capacitor. Pure ac is very hard to find in reality, almost all the electrical power in reality always contains both ac and dc components. To solve the problem, an inventive energy discharge capacitor capable of dissipating both ac and dc electrical power is revealed in the present invention.

An inventive open circuit device having micro needle array, inventive open circuit device damper having damping function and inventive energy discharge capacitor capable of dissipating both ac and dc electrical power will be used in an inventive power regenerator in the present invention.

### SUMMARY OF THE INVENTION

A first object of the present invention is to provide an inventive open circuit device built with nanoscaled material used to form micro needle array featuring more precise control of the occurences of electrical discharges and electrical discharges between nanoscaled materials of the open circuit device have featured more randomly scattering effect for avoiding electrical discharges occurring at same locations.

A second object of the present invention is to provide an inventive open circuit device damper having a threshold voltage which can be controlled by an energy field.

A third object of the present invention is to provide a second energy discharge capacitor having ac and dc powers dissipation capability formed by a first energy discharge capacitor and an inductor coupling with the first energy discharge capacitor.

A fourth object of the present invention is to provide a saturable or a partially saturable magnetic core to the inductor of the second energy discharge capacitor to increase the inductive variations of the second energy discharge capacitor.

A fifth object of the present invention is to provide a second energy discharge capacitor having variable capacitances, inductances, and resistances as an impedance network.

A sixth object of the present invention is to provide an inventive damper formed by an inventive open circuit device damper and an inventive second energy discharge capacitor electrically connected in series.

A seventh object of the present invention is to provide a power regenerator comprising a switching circuit and a magnetic amplifier coupling with the switching circuit for collecting electrical power back.

An eighth object of the present invention is to provide a saturable or a partially saturable magnetic core into a power regenerator to improve its performance.

A nineth object of the present invention is to provide an inventive magnetic core having different magnetic saturation level sections used in a power regenerator.

### BRIEF DESCRIPTION OF THE DRAWINGS

FIG. 1a has shown a prior-art boost circuit;

FIG. 1b has shown a prior-art switching circuit in a general form having a reaction circuit;

FIG. 1c has shown the switching circuit of FIG. 1b of which the action/reaction isolation device is a capacitor and the damper is a PDR device and a NDR device electrically connected in series;

FIG. 1d has shown the switching circuit of FIG. 1b of which the action/reaction isolation device is a diode and the damper is a PDR device and a NDR device electrically connected in series;

FIG. 1e has shown the switching circuit of FIG. 1c of which the PDR device and the NDR device are respectively a PTC and a NTC;

FIG. 1f has shown an embodiment of the switching circuit of FIG. 1e of which the frequency modulator is a transistor switched by a positive on-duty multi-waveform or a negative on-duty multi-waveform;

FIG. 1g has shown a prior-art blocking oscillator;

FIG. 1h has shown the switching circuit of FIG. 1b of which the action/reaction isolation device and the damper are realized by an energy discharge capacitor;

FIG. 2a has shown a first open circuit device;

FIG. 2b has shown a second open circuit device or a first open circuit device damper;

FIG. 2c has shown a third open circuit device or a second open circuit device damper;

FIG. 2d has shown a prior-art first energy discharge capacitor;

FIG. 2e has shown an inventive second energy discharge capacitor;

FIG. 2f has revealed an embodiment of a second energy discharge capacitor an electrical connection between the inductor and the first energy discharge capacitor of FIG. 2d;

FIG. 2g has shown an embodiment of the second open circuit device or the first open circuit device damper of FIG. 2b and the first energy discharge capacitor of FIG. 2d electrically connected in series;

FIG. 2h has shown an embodiment of the second open circuit device or the first open circuit device damper of FIG. 2b and the second energy discharge capacitor of FIG. 2e electrically connected in series;

FIG. 2i has shown an embodiment of the third open circuit device or the second open circuit device damper of FIG. 2c and the first energy discharge capacitor of FIG. 2d electrically connected in series;

FIG. 2j has shown an embodiment of the third open circuit device or the second open circuit device damper of FIG. 2c and the second energy discharge capacitor of FIG. 2e electrically connected in series;

FIG. 2k has shown FIG. 2i with the first terminal and the second terminal of the third open circuit device or the second open circuit device damper of FIG. 2i are respectively specified as a first PDR device and a first NDR device and the first electrode and the second electrode of the first energy discharge capacitor of FIG. 2i are respectively specified as a second PDR device and a second NDR device;

FIG. 2l has shown FIG. 2j with the first terminal and the second terminal of the third open circuit device or the second open circuit device damper of FIG. 2i are respectively specified as a first PDR device and a first NDR device and the first electrode and the second electrode of the second energy discharge capacitor of FIG. 2i are respectively specified as a second PDR device and a second NDR device;

FIG. 2m has shown an embodiment of a threshold voltage of a first open circuit device, a second open circuit device, a third open circuit device, a fourth open circuit device, a first open circuit device damper, or a second open circuit device damper can be affected by or controlled by an energy field;

FIG. 2n has shown an embodiment of a magnetic core formed by a plurality of magnetic conductors piled up with one magnetic conductor laying on another magnetic conductor;

FIG. 3a has shown an embodiment of a first power regenerator;

FIG. 3b has shown an embodiment of a second power regenerator;

FIG. 3c has shown the embodiment of FIG. 3b with the damper and the action/reaction isolation circuit device are specified by the second energy discharge capacitor and the second open circuit device damper electrically connected in series;

FIG. 4a has shown an embodiment that a magnetic conductor can have different magnetic saturation level sections by defining different cross section areas in the magnetic core;

FIG. 4b has shown an embodiment that a magnetic conductor can have different magnetic saturation level sections by using different magnetic materials;

FIG. 4c has shown an embodiment that a magnetic conductor can have different magnetic saturation level sections under different annealing treatments;

FIG. 4d has shown an embodiment of a seven-layer magnetic core having different magnetic saturation level portions;

FIG. 4e has shown the seven-layer magnetic core of FIG. 4d in side view;

FIG. 4f has shown the seven-layer magnetic core of FIG. 4d in top view;

FIG. 4g has shown a top view of a first magnetic conductor of the seven-layer magnetic core of FIG. 4d;

FIG. 4h has shown a top view of a second magnetic conductor of the seven-layer magnetic core of FIG. 4d;

FIG. 4i has shown an embodiment of the first magnetic core of FIG. 3a, 3b or 3c formed by a second magnetic core and a third magnetic core in side view magnetically coupling with the second magnetic core;

FIG. 4j is a top view of the second magnetic core and the third magnetic core of FIG. 4i;

FIG. 4k has shown an embodiment of the first magnetic core of FIG. 3a, 3b or 3c formed by a second magnetic core and a third magnetic core forming a closed magnetic loop with the second magnetic core;

FIG. 4l has shown the inductive load of FIG. 3a, 3b or 3c in a magnetically interactive distance with the first magnetic core as a magnetic compensation to the first magnetic core of FIG. 4j; and

FIG. 4m has specified the inductive load of FIG. 4l as an electric motor or electric generator.

### DETAILED DESCRIPTION OF THE INVENTION

If a first magnetic conductor is saturated by a magnetization, then the first magnetic conductor is called “saturable magnetic conductor” by the magnetization in the present invention. The magnetization can be current flowing through a first coil winding on the first magnetic conductor, a magnetic field from a static magnet nearby, or a magnetic field produced by current flowing through a second coil winding on a second magnetic conductor nearby.

If a first magnetic conductor is not saturated by a magnetization, then the first magnetic conductor is called “unsaturable magnetic conductor” by the magnetization in the present invention. The magnetization can be current flowing through a first coil winding on the first magnetic conductor, a magnetic field from a static magnet nearby, or a magnetic field produced by current flowing through a second coil winding on a second magnetic conductor nearby.

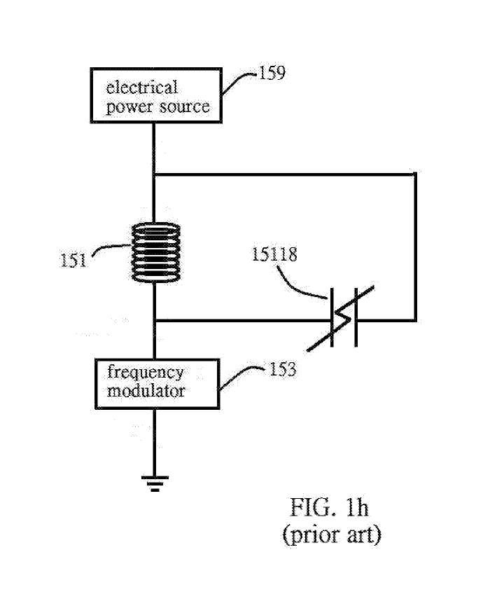

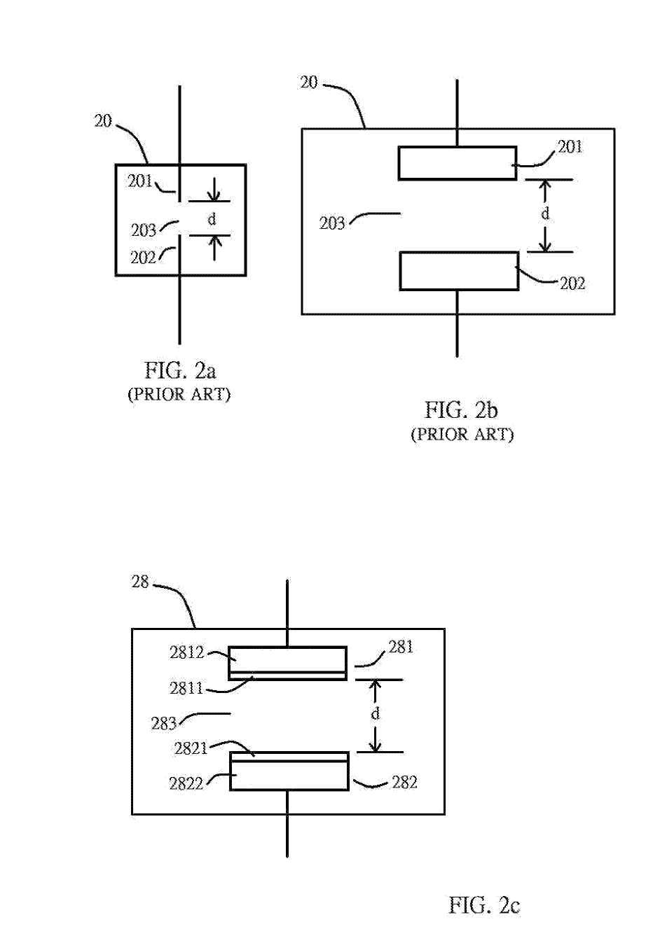

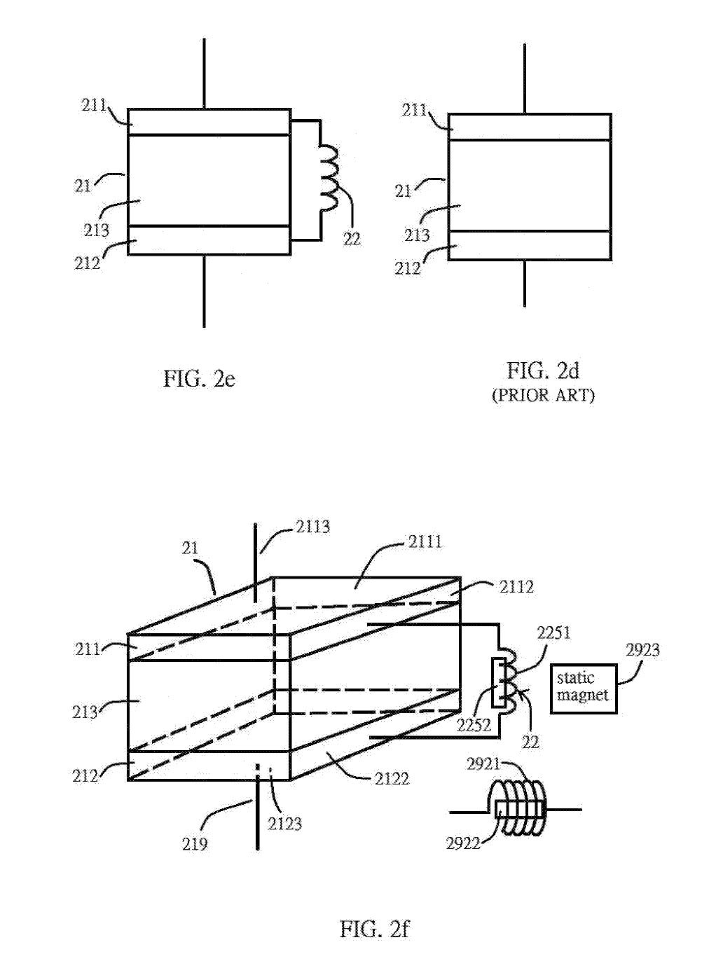

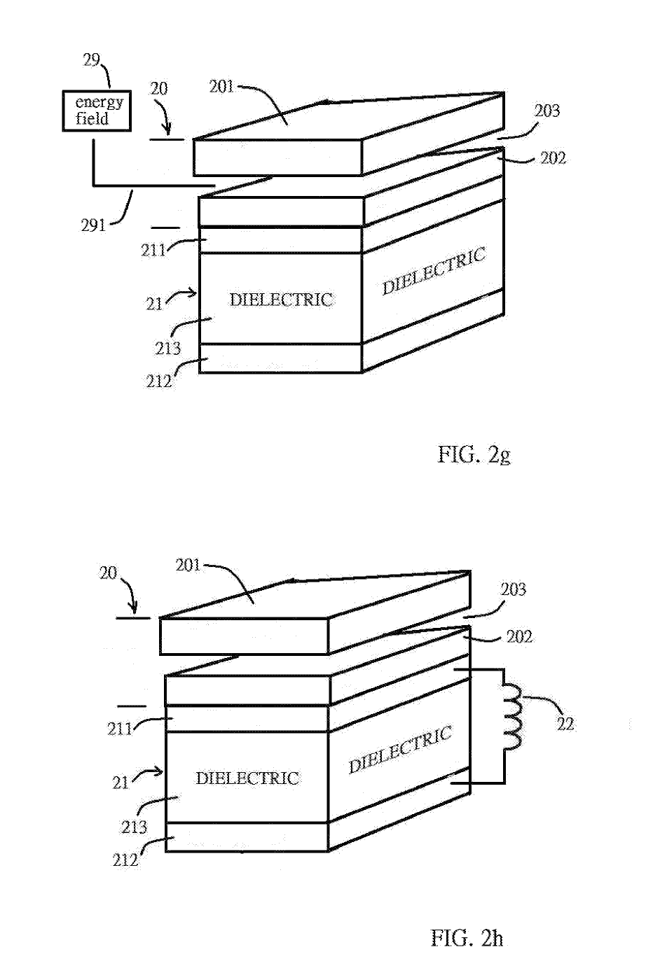

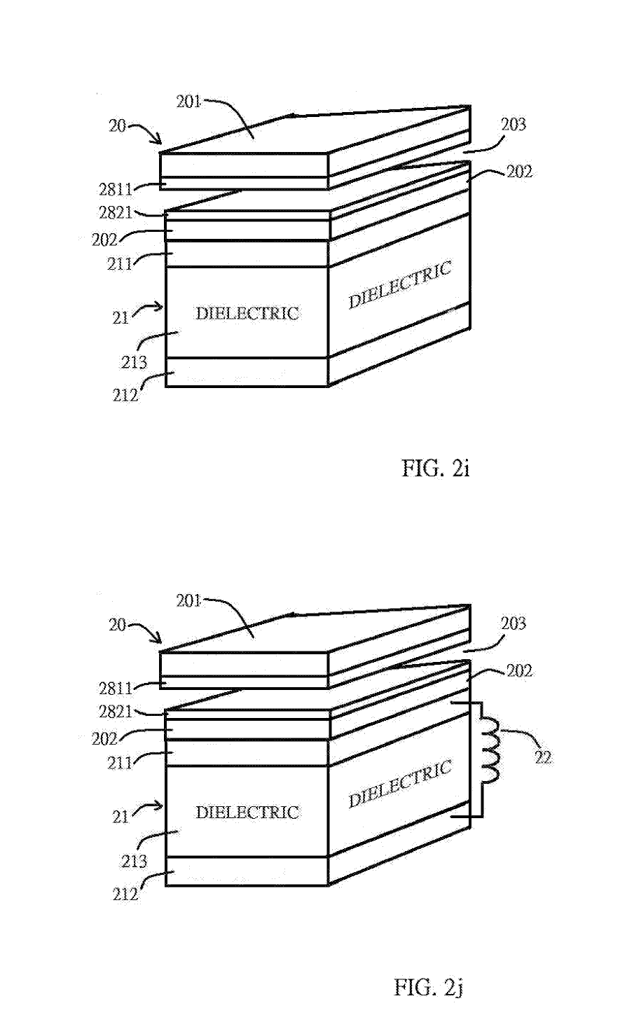

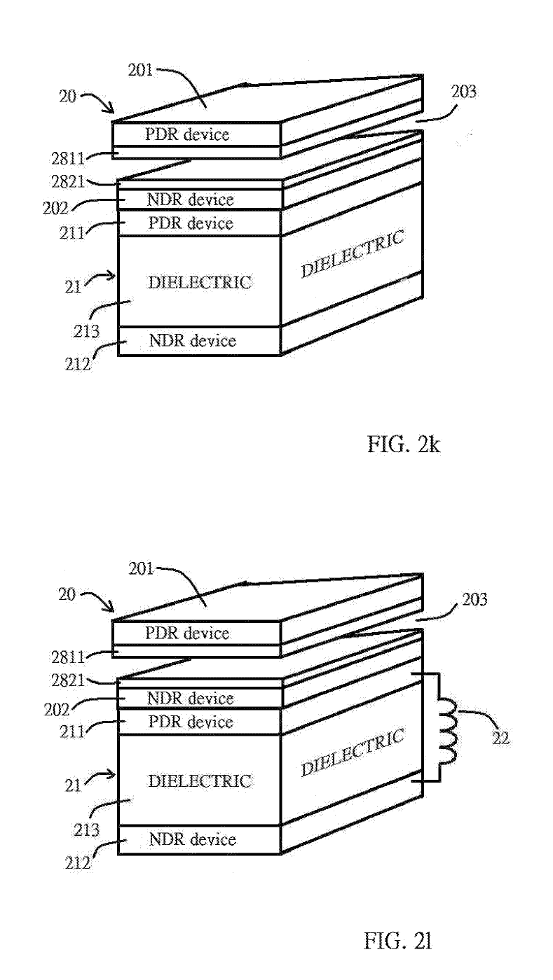

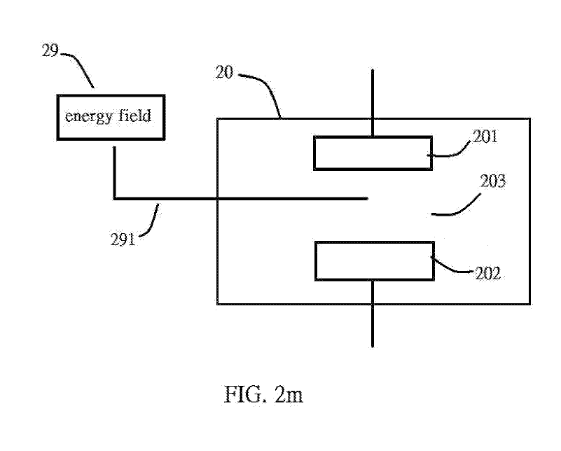

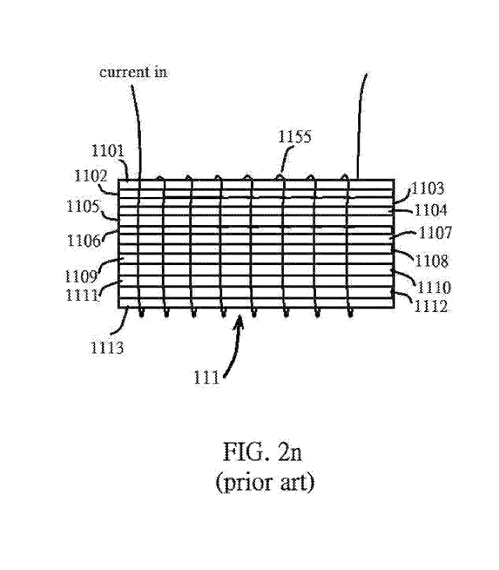

A magnetic core is formed by at least a magnetic conductor. For example, FIG. 2n has shown a magnetic core 111 formed by a plurality of magnetic conductors piled up with one magnetic conductor laying on another magnetic conductor. FIG. 2n has shown a plurality of magnetic conductors 1101˜1103 in side view piled up with one magnetic conductor laying on another magnetic conductor to form the magnetic core 111. FIG. 2n has also shown a coil 1155 winding around the plurality of magnetic conductors. Two adjacent magnetic conductors of the magnetic core may be electrically isolated. For example, an embodiment, an electrical isolator is disposed between two adjacent magnetic conductors. By using FIG. 2n, a plurality of magnetic conductors 1101, 1103, 1105, 1107, 1109, 1111, and 1113 and a plurality of electrical isolators 1102, 1104, 1106, 1108, 1110, and 1112 are seen with one electrical isolator disposed between two adjacent magnetic conductors. The saturation level of each magnetic conductor may be different from that of another magnetic conductor in a magnetic core.

If all the magnetic conductors of a magnetic core are saturated by a magnetization, then the magnetic core is called “saturable magnetic core” by the magnetization in the present invention. The magnetization can be current flowing through a first coil winding on all the magnetic conductors of the magnetic core, a magnetic field from a static magnet nearby, or a magnetic field produced by current flowing through a second coil winding on a second magnetic core nearby. A plurality of magnetic conductors in a saturable magnetic core may be different from each other in saturating level so that the plurality of magnetic conductors are saturated one by one in a sequence. If a magnetic core has only one magnetic conductor which is a saturable magnetic conductor by a magnetization, then the magnetic core is a saturable magnetic core by the magnetization.

If all the magnetic conductors of a magnetic core are not saturated by a magnetization, then the magnetic core is called “unsaturable magnetic core” by the magnetization in the present invention. The magnetization can be current flowing through a first coil winding on all the magnetic conductors of the magnetic core, a magnetic field from a static magnet nearby, or a magnetic field produced by current flowing through a second coil winding on a second magnetic core nearby. If a magnetic core has only one magnetic conductor which is a unsaturated magnetic conductor by a magnetization, then the magnetic core is a unsaturable magnetic core by the magnetization.

If a magnetic core has at least a saturable magnetic conductor and at least a unsaturable magnetic conductor by a magnetization, then the magnetic core is called “partially saturable magnetic core” by the magnetization in the present invention. The magnetization can be current flowing through a first coil winding on all the magnetic conductors of the magnetic core, a magnetic field from a static magnet nearby, or a magnetic field produced by current flowing through a second coil winding on a second magnetic core nearby. A plurality of saturable magnetic conductors in a partially saturable magnetic core may be different from each other in saturating level so that the plurality of saturable magnetic conductors are saturated one by one in a sequence.

An open circuit device comprises a first terminal and a second terminal separating the first terminal by an open gap having an open gap width d and an electrical discharge between the first terminal and the second terminal can take place if a voltage is applied between the first terminal and the second terminal and at least one of the first terminal and the second terminal is a discharge electrode of the electrical discharge. For the purpose of convenience, a voltage applied between a first terminal and a second terminal of an open circuit device for an occurence of an electrical discharge between the first terminal and the second terminal of the open circuit device is called “electrical discharge voltage” or “threshold voltage” in the present invention. In other words, an open circuit device has a threshold voltage for an occurence of an electrical discharge. A “threshold voltage” of an open circuit device can be obtained by a suitable design, for example, an embodiment, by adjusting the open gap width d of the open circuit device. The electrical discharge of the open circuit device is not limited, for example, it can be an electrical corona discharge or electrical glowing discharge.

FIG. 2a has shown a prior-art open circuit device 20 marked by a rectangle comprising a first terminal 201 and a second terminal 202 separating the first terminal 201 by an open gap 203 having an open gap width d. An occurence of an electrical discharge between the first terminal 201 and the second terminal 202 of the open circuit device 20 can be decided by a voltage across the first terminal 201 and the second terminal 202, the frequency of the voltage applied between the first terminal 201 and the second terminal 202, the open gap width d of the open gap 203 between the first terminal 201 and the second terminal 202, a medium disposed between the first terminal 201 and the second terminal 202, an ionization condition between the first terminal 201 and the second terminal 202, an electrical field between the first terminal 201 and the second terminal 202, temperature variation between the first terminal 201 and the second terminal 202, the shapes of the first terminal 201 and the second terminal 202, and/or the materials made of the first terminal 201 and the second terminal 202, etc. For example, an embodiment, a medium disposed in the open gap 203 can be a gas such as air or inert gas for isolating the first terminal 201 and the second terminal 202 from outside environment against oxidizing. For another example, an embodiment as shown in FIG. 2m, an energy field 29 applied through a medium 291 disposed by the open circuit device 20 to affect the conductivity and ionization between the first terminal 201 and the second terminal 202 of the open circuit device 20 can play an important role in the occurence of the electrical discharge between the first terminal 201 and the second terminal 202 so that by controlling the energy field 29 can control the occurence of the electrical discharge between the first terminal 201 and the second terminal 202 or its threshold voltage of the open circuit device 20. The energy field 29 is not limited, for example, it can be an electrical field which can affect the conductivity between the first terminal 201 and the second terminal 202 of the open circuit device 20, it can be a magnetic field which can affect the ionization between the first terminal 201 and the second terminal 202 of the open circuit device 20, or it can be a thermal field which can affect the temperature condition between the first terminal 201 and the second terminal 202 of the open circuit device 20.

The shapes of the first terminal 201 and the second terminal 202 are not limited, for example, the first terminal 201 and the second terminal 202 can be respectively shaped as needle point as shown in FIG. 2a advantaging for more precise control of an occurence of an electrical discharge and easier occurence of the an electrical discharge or shaped having an area as shown in FIG. 2b which can be viewed to be formed by a plurality of needle points featuring multiple electrical discharges between the first terminal 201 and the second terminal 202 and more precise control of occurences of multiple electrical discharges. Multiple electrical discharges between the first terminal 201 and the second terminal 202 of the open circuit device 20 shown in FIG. 2b features bigger current capability flowing between the first terminal 201 and the second terminal 202 of the open circuit device 20 at electrical discharges. For the purpose of convenience, the open circuit devices respectively of FIG. 2a and FIG. 2b are respectively called a first open circuit device and a second open circuit device in the present invention.

Needle points can be in micro or nano scale if the first terminal 201 and the second terminal 202 of an open circuit device 20 have nanoscaled materials having electrical discharges between them. Smaller scaled needle points feature higher density of needle points, more numbers of electrical discharges between the first terminal 201 and the second terminal 202, bigger current capability flowing between the first terminal and the second terminal of the open circuit device, and more complicated electrical discharge routes for more avoiding electrical discharges keeping at same discharge routes.

For the purpose of convenience, a plurality of microscaled or nanoscaled needle points of the first terminal 201 and the second terminal 202 of the open circuit device 20 can also be called “micro needle array” in the present invention.

The behavior of the electrical discharge of the open circuit device 20 is very complicated, which can be seen in its I-V curve. Explaining the complicated behavior in a simple way, the complicated behavior of the electrical discharge of the open circuit device 20 can be categoried into a PDR (Positively Differential Resistance), a NDR (Negatively Differential Resistance) and a constant resistance. By using FIG. 2a as an example, when a voltage built between the first terminal 201 and the second terminal 202 of the open circuit device 20 reaches its “threshold voltage”, an electrical discharge takes place causing current to flow through the first terminal 201 and the second terminal 202 to present a NDR, then the voltage across the first terminal 201 and the second terminal 202 will drop to a level by the NDR unable to keep the electrical discharge, then current stops flowing between the first terminal 201 and the second terminal 202 and a voltage across the first terminal 201 and the second terminal 202 will be built again to present a PDR until reaching to a next discharge voltage for a next electrical discharge. The PDR and the NDR will alternatively proceed with its current between zero and a non-zero value and its impedance chaotically randomly varying between zero and infinity. A alternative PDR and NDR can also be referred to “tunneling” in the present invention. The term “tunneling” is a more conventional term known by the people skilled in the art.

Nanoscaled material or nanoscaled device can be viewed to be formed or treated by nanoscaled particles which can be reasonably viewed as “micro needle array”. A conductive nanoscaled material (or called a conductive nanoscaled device) is not limited, for example, it can be a Carbon-Nano Tube or CNT in short in the present invention, a graphene, a diamond-like carbon or DLC in short, or C₆₀ family. “A conductive nanoscaled device” includes a CNT, a graphene, a diamond-like carbon, or C₆₀ family in the present invention.

A first embodiment, the first terminal 201 and the second terminal 202 of the open circuit device 20 of FIG. 2b respectively can be made of a conductive nanoscaled device having micro needle array. For the purpose of convenience, the open circuit device of the first embodiment is called a third open circuit device in the present invention.

A second embodiment, an open circuit device is shown in FIG. 2c, FIG. 2c has shown a first terminal 281 of the open circuit device is formed by a first conductive nanoscaled device 2811 and a first conductor 2812 electrically connecting to the first conductive nanoscaled device 2811, a second terminal 282 of the open circuit device 28 is formed by a second conductive nanoscaled device 2821 and a second conductor 2822 electrically connecting to the second conductive nanoscaled device 2821, and an open gap 283 is formed between the first conductive nanoscaled device 2811 and the second conductive nanoscaled device 2821. Electrical discharges take place between the first conductive nanoscaled device 2811 and the second conductive nanoscaled device 2821. For the purpose of convenience, the open circuit device of the second embodiment is called a fourth open circuit device in the present invention.

A third embodiment based on the open circuit device shown in FIG. 2b, any one of the first terminal 201 and the second terminal 202 of the open circuit device 20 shown in FIG. 2b can be a PDR device and the other one of the first terminal 201 and the second terminal 202 of the open circuit device 20 can be a NDR device. An electrical discharge between a PDR device and a NDR device of an open circuit device presents NDR and PDR simultaneously so that the open circuit device is a damper which can be used to dissipate electrical power. For the purpose of convenience, the open circuit device of the third embodiment is called a first open circuit device damper in the present invention.

A fourth embodiment based on the open circuit device of FIG. 2c, any one of the first conductor 2812 and the second conductor 2822 of the second embodiment of the open circuit device 28 shown in FIG. 2c can be a PDR device and the other one can be a NDR device. An electrical discharge between the first conductive nanoscaled device 2811 and the second conductive nanoscaled device 2821 of an open circuit device presents NDR and PDR simultaneously so that the open circuit device is a damper which can be used to dissipate electrical power. Obviously, at an occurence of an electrical discharge at a threshold voltage, the open circuit device 28 having PDR and NDR simultaneously functions as a damper which can be used to dissipate electrical power. For the purpose of convenience, the open circuit device of the fourth embodiment is called a second open circuit device damper in the present invention. Obviously, the first open circuit device damper and the second open circuit device damper can respectively be viewed as an open circuit device and a damper.

The PDR device and the NDR device are not limited. The PDR device can be easily found anywhere, for example, an embodiment, the PDR device can be a Positive Temperature Coefficient (or PTC in short). The NDR device can be a metal oxided material such as ZnO or a Negative Temperature Coefficient (or NTC in short) as revealed in the background information above.

The embodiment of FIG. 2m is true to the first open circuit device, the second open circuit device, the third open circuit device, the fourth open circuit device, the first open circuit device damper, or the second open circuit device damper.

It's noted that the routes of the multiple electrical discharges between the first terminal and the second terminal may be different from that of its previous multiple electrical discharges because the conditions affecting to the occurences of the multiple electrical discharges such as temperature and the applied voltage keep changing all the time. The randomly scattering effect of the multiple electrical discharges between the first terminal and the second terminal is expected.

Some experiments have shown the tunneling can take place at two touching conductors. An open circuit device can be formed by having a loose connection such as touching or slight touching between its first terminal and second terminal, in other words, an open gap can be formed between two touching or slightly touching conductors of an open circuit device.

A prior-art energy discharge capacitor 21 as shown in FIG. 2d comprises a first electrode 211, a second electrode 212, and a dielectric 213 disposed between the first electrode 211 and the second electrode 212 and any one of the first electrode 211 and the second electrode 212 is a PDR device and the other one electrode is a NDR device. Obviously, the energy discharge capacitor is a damper which can dissipate ac (alternating current) going through it.

Almost all the electrical power include an ac (alternate current) component and a dc (direct current) component. Pure ac is not easy to find in reality. A fifth embodiment shown in FIG. 2e that has shown an inventive energy discharge capacitor formed by the prior-art energy discharge capacitor 21 of FIG. 2d and an inductor 22 electrically connected to the PDR device and the NDR device of the energy discharge capacitor 21. Capacitor is a high frequency ac device and features current lead and inductor is good for low frequency ac and dc.

A high frequency ac of an electrical power will choose to go through the energy discharge capacitor 21 and gets dissipated and a low frequency and dc component of the electrical power will choose to go through the inductor route containing the PDR device, the NDR device, and the inductor 22 and get dissipated. Obviously, the inventive energy discharge capacitor of the fifth embodiment of FIG. 2e has capability to dissipate both ac and dc electrical powers. An electrical power can be viewed to diverge between the energy discharge capacitor 21 and the inductor route containing the NDR device, the inductor 22, and the PDR device by bandwidth. An electrical power divergence by bandwidth at the energy discharge capacitor 21 and the inductor 22 can be viewed as a destruction of the electrical power into smaller electrical powers. In other words, a dangerous high surge electrical power can be viewed to be cut into smaller and safer electrical powers by the divergence of the inventive energy discharge capacitor of the fifth embodiment of FIG. 2.

For the purpose of convenience, the prior-art energy discharge capacitor of FIG. 2d is called a first energy discharge capacitor in the present invention and the inventive energy discharge capacitor of the fifth embodiment of FIG. 2e is called a second energy discharge capacitor in the present invention.

A sixth embodiment shown in FIG. 2f is based on the fifth embodiment of the second energy discharge capacitor 21 of FIG. 2e to reveal the electrical connection between the inductor 22 and the energy discharge capacitor 21. FIG. 2f has shown the first electrode 211 of the second energy discharge capacitor 21 has a first surface 2111 electrically connecting to a first terminal 2113 and a second surface 2112 different from the first surface 2111 and the second electrode 212 of the second energy discharge capacitor 21 has a first surface 2121 electrically connecting to a second terminal 2123 and a second surface 2122 different from the first surface 2121. The first terminal 2113 and the second terminal 2123 respectively express to be used to electrically connect to an outside circuit. The inductor 22 electrically connects to the second surface 2112 of the first electrode 211 and the second surface 2122 of the second electrode 212.

As shown in the sixth embodiment shown of FIG. 2f, the inductor 22 can be formed by a first magnetic core 2252 and a first coil 2251 winding on the first magnetic core 2252. The first magnetic core 2252 can be saturated or partially saturated by current flowing the first coil 2251, a magnetic field from a static magnetic core 2923 nearby or a magnetic field produced by current flowing through a second coil 2921 winding around a second magnetic core 2922 nearby.

At the saturation or partially saturation of the first magnetic core 2252 of the inductor 22, the inductance of the inductor 22 will vary to become zero or smaller to less limit the current flowing through the first coil of the inductor 22. Obviously, the second energy discharge capacitor is a damper capable of dissipating both ac and dc electrical powers and featuring variable capacitances, inductances and resistances. The second energy discharge capacitor featuring variable capacitances, inductances and resistances can also be viewed as an impedance network.

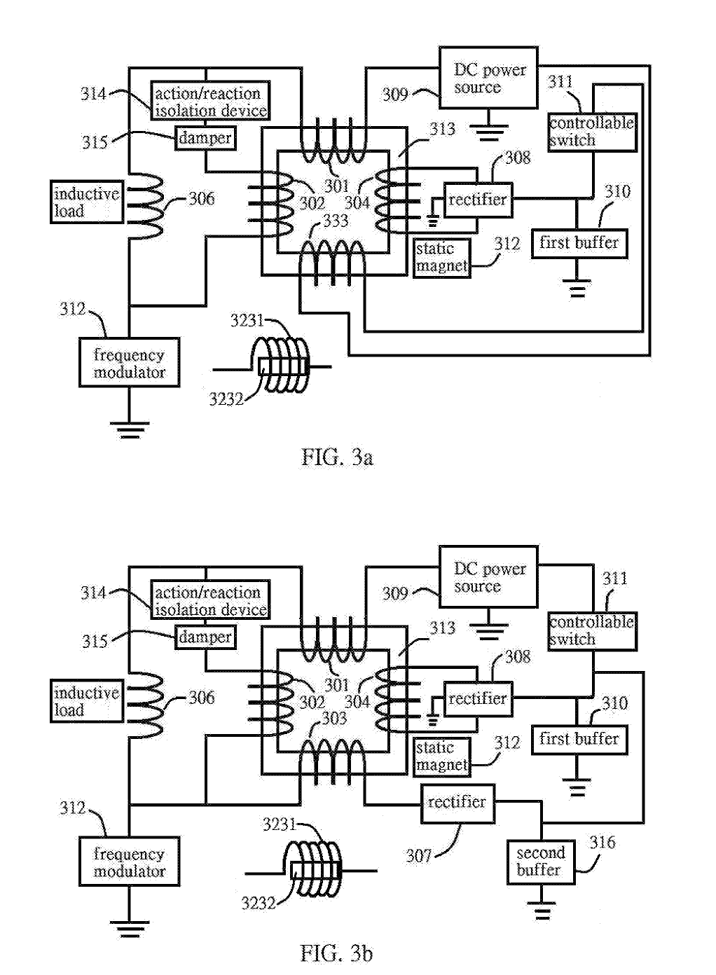

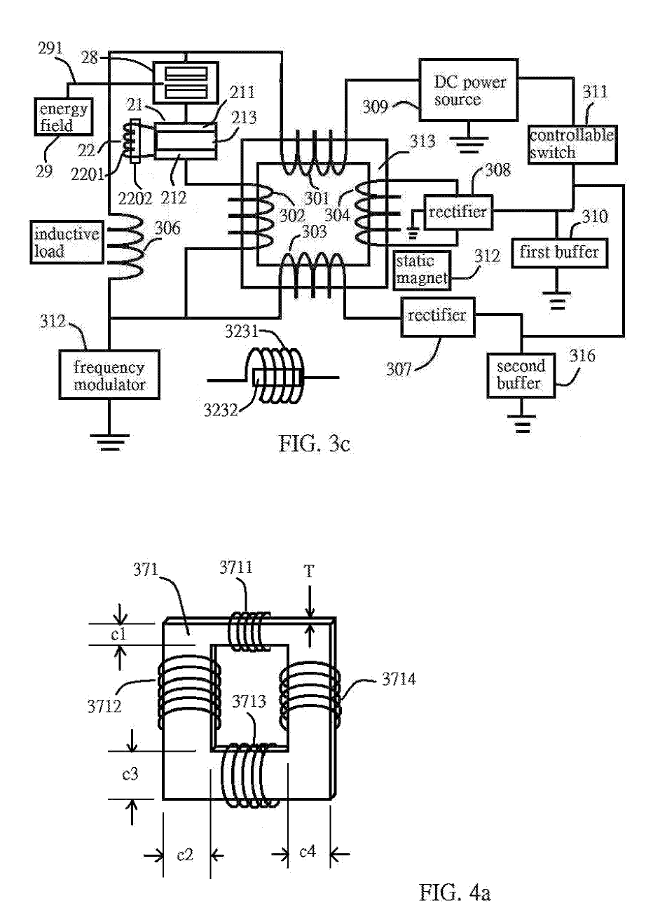

A dc from a power source of a switching circuit and a reaction to an action of the switching circuit as a Lenz electrical power can be respectively used as a dc input and an ac input to a first magnetic core to form a magnetic amplifier to collect back electrical power. A seventh embodiment of a first power regenerator is shown in FIG. 3a. FIG. 3a has shown a first power regenerator formed by a switching circuit trying to be in a general form and a magnetic amplifier coupling with the switching circuit. The switching circuit comprises an electrical power source 309, a low pass filter coil 301 or simply a first coil 301 as revealed earlier in the background information, an inductive load 306, and a frequency modulator 312 electrically connected in series with each other. The electrical power source 309 provides electrical power such as a dc electrical power source to drive the inductive load 306 and the frequency modulator 312 provides switchings or frequency in the switching circuit.

A first reaction circuit comprises a second coil 302, a damper 315, and an action/reaction isolation device 314 electrically connected in series with each other. The first reaction circuit and the inductive load 306 are in parallel. The damper 315 of the first reaction circuit is for dissipating the Lenz power flowing through the first reaction circuit.

The low pass filter coil 301 of the power or the first coil 301 winds around a first magnetic core 313 so that a dc provided by the power source 309 flowing through the first coil 301 provides a dc input to the first magnetic core 313. The second coil 302 of the first reaction circuit winds around the first magnetic core 313 so that Lenz power goes through the second coil 302 provides ac input to the first magnetic core 313. The first coil 301 and the second coil 302 winding around the first magnetic core 313 forms a magnetic amplifier and an amplified output of the magnetic amplifier is taken at a fourth coil 304 winding around the first magnetic core 313. A magnetic flux flowing in the first magnetic core 313 respectively produced by current flowing through the first coil 301 and the second coil 302 should be in a same orientation or the first coil 301 and the second coil 302 should be “coil-wiring-in-phase” so that the wiring orientations of the first coil 301 and the second coil 302 around the first magnetic core 313 should be taken into consideration.

The ac output current taken at the fourth coil 304 on the first magnetic core 313 can be rectified by a first rectifier 308 to charge into a first buffer 310 and by operating a controllable switch 311 a voltage of the first buffer 310 higher than the DC power source 309 can either directly charge into the electrical power source 309 or go through a fifth coil 333 winding on the first magnetic core 313 as shown in FIG. 3a to then charge into the electrical power source 309. The dc after the first rectifier 308 going through the fifth coil 333 can also provide dc excitation to the first magnetic core 313 and can also function to filter high frequency component. A static magnet 312 can be disposed within a magnetically interactive distance with the first magnetic core 313 as a magnetic compensation to the first magnetic core 313 to improve magnetic efficiency of the first magnetic core 313.

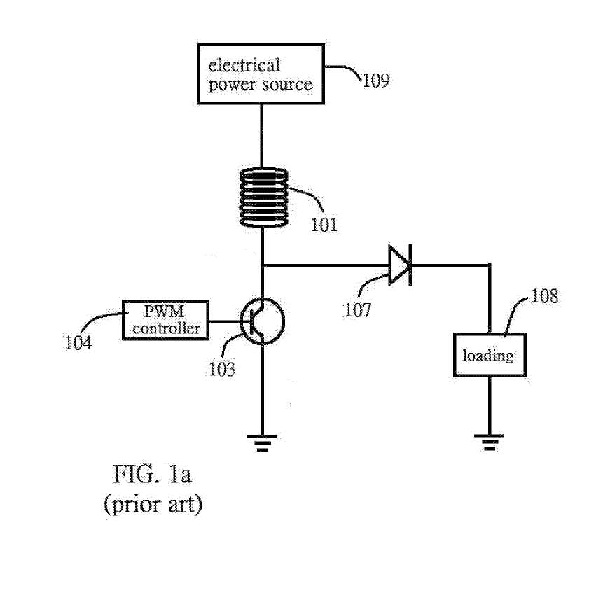

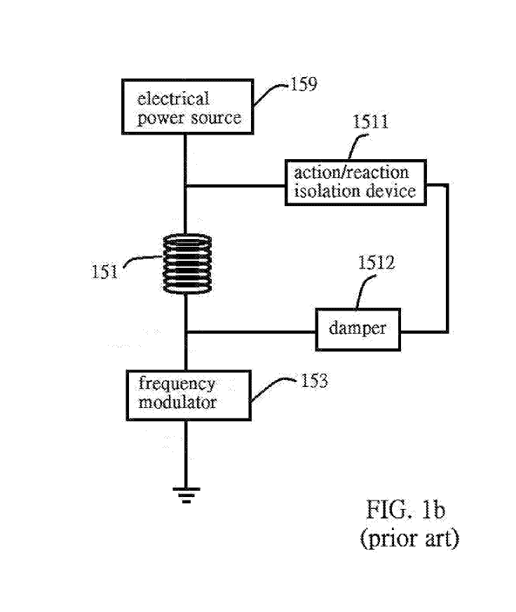

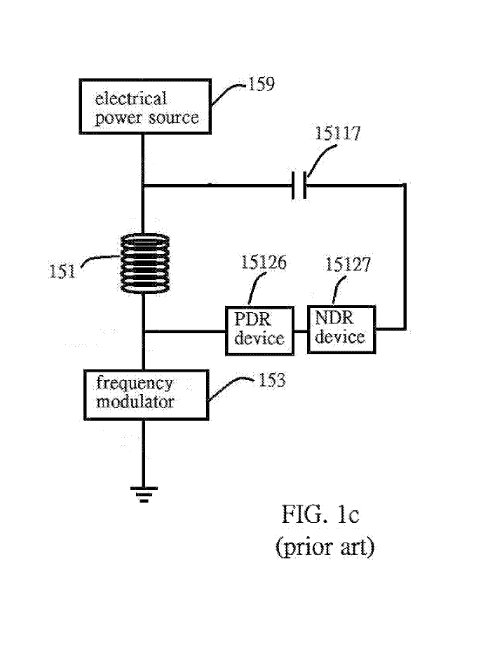

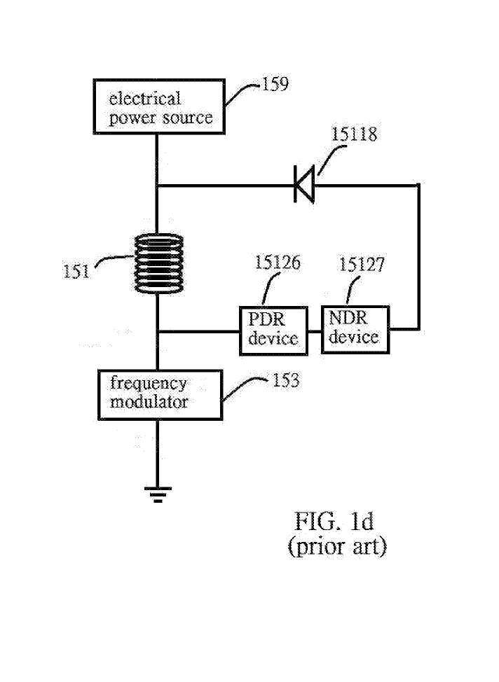

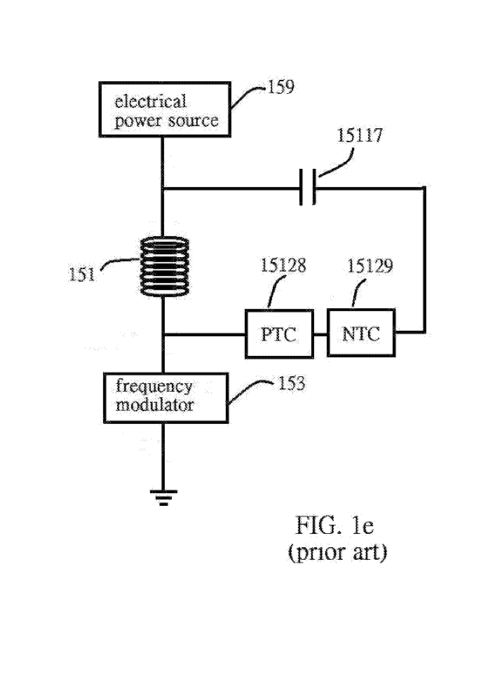

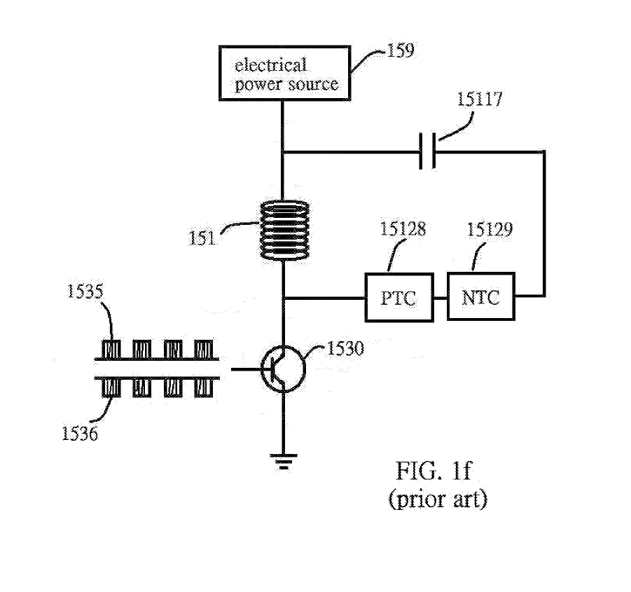

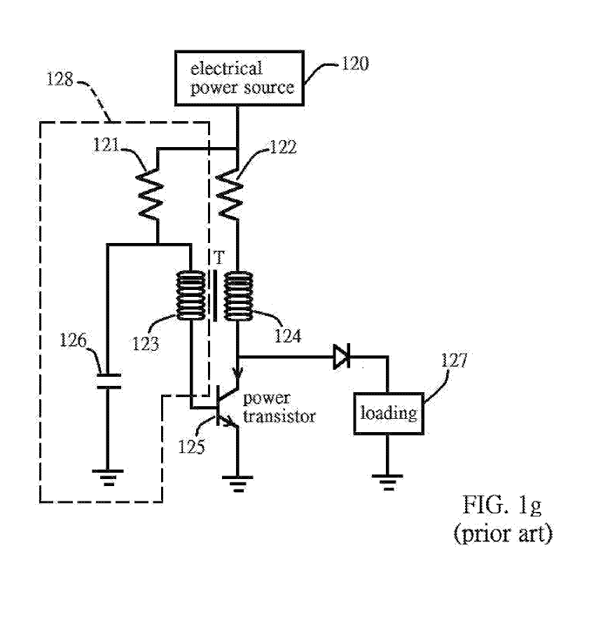

The size, the shape, the structure of the first magnetic core 313 are not limited, and the material made of the first magnetic core 313 are not limited. The first rectifier 308 is not limited, for example, the first rectifier 308 can be a diode such as a high-speed diode. The first buffer 310 is not limited, for example, the first buffer 310 can be a capacitor such as a polarized capacitor, a battery, a superconductive coil, or a flywheel. The controllable switch 311 is not limited, for example, it can be a controllable transistor. The frequency modulator 312 is not limited, for example, it can be a switch controlled by a given waveform from a PWM controller as shown in FIG. 1a or a self-excitation switch. The inductive load 306 is not limited, for example, it can be an inductor, an electric motor, an electric generator, or a transformer. The electrical power source 309 is not limited, for example, the electrical power source 309 can be a dc power source such as a battery, a fuel cell, a capacitor or a photo-electricity conversion device such as solarcell battery.

The Lenz power will be dissipated in the damper 315 and the dissipated Lenz power in the first reaction circuit provides weak ac input to the first magnetic core 313.

To solve the problem is to have a second reaction circuit in parallel to the first reaction circuit and the inductive load 306 as shown in a second power regenerator shown in FIG. 3b. Based on the seventh embodiment of FIG. 3a and shown in an eighth embodiment shown in FIG. 3b, FIG. 3b has shown a second reaction circuit, the first reaction circuit and the inductive load 306 are in parallel with each other. The second reaction circuit comprises a third coil 303, a second rectifier 307, and a second buffer 316 electrically connected in series with each other. The third coil 303 winds on the first magnetic core 313.

The first reaction circuit is designed for passing high frequency Lenz power and the second reaction circuit is designed for passing low frequency Lenz power. The high frequency Lenz power is more unpredictable and has more potential to quickly build very high peak so that the damper 315 in the first reaction circuit is used to dissipate it to secure the circuit and the lower and safer frequency Lenz power chooses to go through the second reaction circuit. A Lenz power produced by the switching circuit diverges between the first reaction circuit and the second reaction circuit by bandwidth. Lenz power flowing through the first reaction circuit and the second reaction circuit provides ac inputs to the first magnetic core 313.

The inductance and capacitance in the first reaction circuit and the second reaction circuit play important role in bandwidth. For example, an embodiment, the second coil 302 can have fewer number of coil turns than that of the third coil 303 so that high frequency ac will tend to go through the first reaction circuit. The diameter of the third coil 303 of the second reaction circuit can be larger than that of the second coil 302 of the first reaction circuit to allow bigger current to go through the second reaction circuit. The capacitance discrepancies between the first reaction circuit and the second reaction circuit also play important role in bandwidth. The energy discharge capacitor having varying capacitances is good for expanding bandwidth.

Seen in FIG. 3b, the low pass filter coil 301 or the first coil 301 winds on the first magnetic core 313 so that a dc provided by the electrical power source 309 flowing through the first coil 301 provides a dc input to the first magnetic core 313. The second coil 302 of the first reaction circuit and the third coil 303 of the second reaction circuit respectively wind on the first magnetic core 313 so that Lenz power goes through the second coil 302 and the third coil 303 provide ac inputs to the first magnetic core 313. The first coil 301, the second coil 302, and the third coil 303 winding on the first magnetic core 313 forms a magnetic amplifier and an amplified output of the magnetic amplifier is taken at the fourth coil 304 winding on the first magnetic core 313. A magnetic flux flowing in the first magnetic core 313 respectively produced by current flowing through the first coil 301, the second coil 302, and the third coil 303 should be in a same orientation so that the orientations of the wirings of the first coil 301, the second coil 302, and the third coil 303 on the first magnetic core 313 should be taken care of.

An ac Lenz current flowing through the second reaction circuit and the ac output current taken at the fourth coil 304 on the first magnetic core 313 can be respectively rectified to respectively charge the second buffer 316 and the first buffer 310. The second buffer 316 can be the first buffer 310. By operating a controllable switch 311 a voltage of the first buffer 310 or the second buffer 316 higher than the DC power source 309 can charge back into the electrical power source 309 as shown in FIG. 3b. The second buffer 316 is not limited, for example, the second buffer 316 can be a capacitor such as a polarized capacitor, a battery, a superconductive coil or a flywheel. For the purpose of simplication of the drawing, the fifth coil 333 of FIG. 3a is not drawn in FIG. 3b.

If a threshold voltage of an open circuit device or an open circuit device damper is higher than a voltage of the electrical power source 309, then a current from the electrical power source 309 will be blocked against flowing into the first reaction circuit so that the open circuit device or the open circuit device damper can function as an action/reaction isolation device. The open circuit device mentioned here includes the first open circuit device, the second open circuit device, the third open circuit device and the fourth open circuit device and the open circuit device damper mentioned here includes the first open circuit device damper and the second open circuit device damper.

The damper 315 and the action/reaction isolation device 314 in the first reaction circuit of FIG. 3a or FIG. 3b are not limited. The action/reaction isolation device 314 can be a diode, a capacitor that includes the energy discharge capacitor, an open circuit device, or an open circuit device damper. The damper 315 can be a PDR device and a NDR device electrically connected in series, an energy discharge capacitor, or an open circuit device damper. It's noted that the first open circuit device damper and the second open circuit device damper are respectively open circuit devices also viewed as an action/reaction isolation device and also dampers. It's also noted that the first energy discharge capacitor and the second energy discharge capacitor are respectively an action/reaction isolation device and also a damper.

The damper 315 and the action/reaction isolation device 314 in the first reaction circuit can be:

the first open circuit device and the first energy discharge capacitor electrically connected in series, the second open circuit device and the first energy discharge capacitor electrically connected in series, the third open circuit device and the first energy discharge capacitor electrically connected in series, the fourth open circuit device and the first energy discharge capacitor electrically connected in series, the first open circuit device damper and the first energy discharge capacitor electrically connected in series, the second open circuit device damper and the first energy discharge capacitor electrically connected in series, the first open circuit device and the second energy discharge capacitor electrically connected in series, the second open circuit device and the second energy discharge capacitor electrically connected in series, the third open circuit device and the second energy discharge capacitor electrically connected in series, the fourth open circuit device and the second energy discharge capacitor electrically connected in series, the first open circuit device damper and the second energy discharge capacitor electrically connected in series, the second open circuit device damper and the second energy discharge capacitor electrically connected in series, the first open circuit device damper, the second open circuit device damper, the first energy discharge capacitor, the second energy discharge capacitor, a PDR device and a NDR device electrically connected in series and a diode electrically connecting to the PDR device and the NDR device, a PDR device and a NDR device electrically connected in series and a capacitor electrically connecting to the PDR device and the NDR device, a PDR device and a NDR device electrically connected in series and a first energy discharge capacitor electrically connecting to the PDR device and the NDR device, a PDR device and a NDR device electrically connected in series and a second energy discharge capacitor electrically connecting to the PDR device and the NDR device, a PDR device and a NDR device electrically connected in series and a first open circuit device electrically connecting to the PDR device and the NDR device, a PDR device and a NDR device electrically connected in series and a second open circuit device electrically connecting to the PDR device and the NDR device, a PDR device and a NDR device electrically connected in series and a third open circuit device electrically connecting to the PDR device and the NDR device, a PDR device and a NDR device electrically connected in series and a fourth open circuit device electrically connecting to the PDR device and the NDR device, a PDR device and a NDR device electrically connected in series and a first open circuit device damper electrically connecting to the PDR device and the NDR device, or a PDR device and a NDR device electrically connected in series and a second open circuit device damper electrically connecting to the PDR device and the NDR device.

The open circuit device or the open circuit device damper in the first reaction device having a threshold voltage can be viewed to set a “current switch” on current flowing through the first reaction circuit. The open circuit device or the open circuit device damper in the first reaction device can be viewed to produce a “halt” on current against continously flowing through the first reaction circuit. Current flows through the first reaction circuit only with the occurence of the electrical discharge of the open circuit device or the open circuit device damper. At no electrical discharge of the open circuit device or the open circuit device damper in the first reaction device, current will choose to flow through the second reaction circuit. It's expected that a dangerous peak of the Lenz power can be dissipated in the first reaction circuit and as much as the safe portion of the Lenz power can flow through the second reaction circuit.

Lenz power produced by the switching circuit usually has biggest shock at each phase change that will easily go over the threshold of the open circuit device or the open circuit device damper causing current to flow through the first reaction circuit and get dissipated and then the smaller and safer Lenz power not beyond the threshold of the open circuit device or the open circuit device damper in the first reaction circuit will go through the second reaction circuit. A Lenz power diverging between the first reaction circuit and the second reaction circuit by bandwidth can be viewed as a destruction of an incoming Lenz power into smaller electrical powers.

The damper 315 and the action/reaction isolation device 314 of the eighth embodiment of FIG. 3b are specified by a second energy discharge capacitor 21, 22 and a second open circuit device damper 28 electrically connected in series as shown in a nineth embodiment of FIG. 3c. The second energy discharge capacitor is formed by a first energy discharge capacitor 21 and an inductor 22 as revealed in FIG. 2e and FIG. 2f.

Shown in the nineth embodiment of FIG. 3c, the inductor 22 of the second energy discharge capacitor is hard to pass high frequency ac (alternating current) but easy to pass dc (direct current) and low frequency ac and the second energy discharge capacitor 21 is good for passing high frequency ac and features current lead so that an incoming high peak Lenz power flowing through the first reaction circuit will further diverge again between the energy-discharge capacitor 21 and the inductor 22 by bandwidth. The current divergence at different speeds can be viewed as a further destruction of a dangerous high frequency electrical power shock into smaller and safer electrical powers. The inductor 22 can also be used to set a limit on dc current from the electrical power source 309 into the first reaction circuit. It's also noted that FIG. 3c has also shown the threshold voltage of the second open circuit device damper 28 can be adjusted by an energy field 29 in an affecting distance with the second open circuit device damper 28.

The inductor 22 of the second energy discharge capacitor shown in FIG. 3c can be formed by a sixth coil 2201 and a second magnetic core 2202 wound by the sixth coil 2201. The second magnetic core 2202 can be saturated or partially saturated by current flowing through the sixth coil 2201, a magnetic field from a static magnet nearby, or a magnetic field produced by current flowing through the inductive load 306. At the saturation or partial saturation of the second magnetic core 2202 of the inductor 22, the inductance of the inductor 22 will become zero or smaller to less limit the current flowing through the first coil 301 of the inductor 22 and also makes the inductance of the inductor 22 much more variable.

Referring to FIG. 3a, 3b, or 3c, to avoid the first coil 301 limiting the current from the electrical power source 309 to flow through the switching circuit and to avoid the first coil 301 becoming a significant second load of the switching circuit, at least a portion of the first magnetic core 313 wound by the first coil 301 can be saturated or partially saturated by a magnetization so that at the saturation or partial saturation the inductance of the first coil 301 will become zero or smaller to less limit the current flowing through the first coil 301 in the switching circuit. The magnetization can be current from the electrical power source 309 flowing through the first coil 301, the static magnet 312 nearby, current flowing through the second coil 302 and the third coil 303, a magnetic field produced by current flowing through the inductive load 306 or a magnetic field produced by current flowing through a seventh coil 3231 winding around a third magnetic core 3232 nearby.

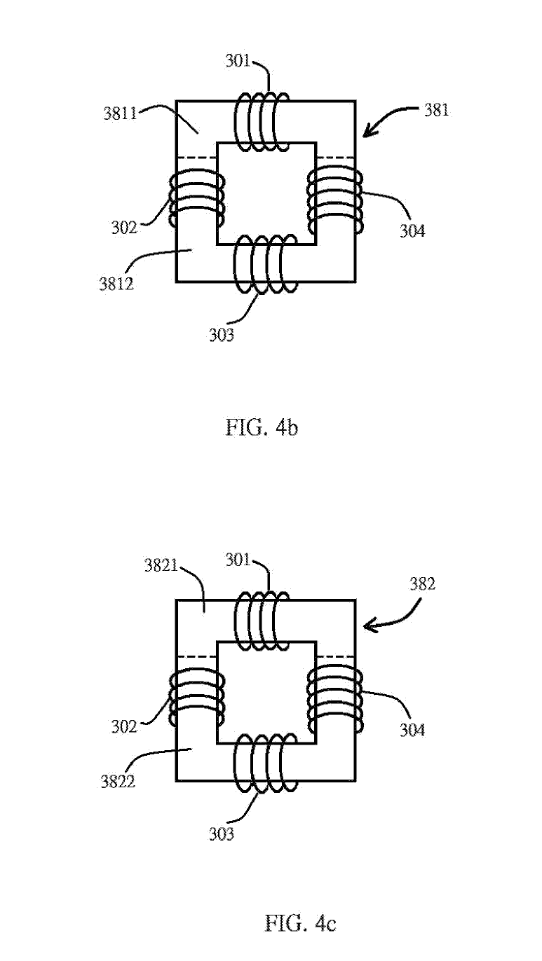

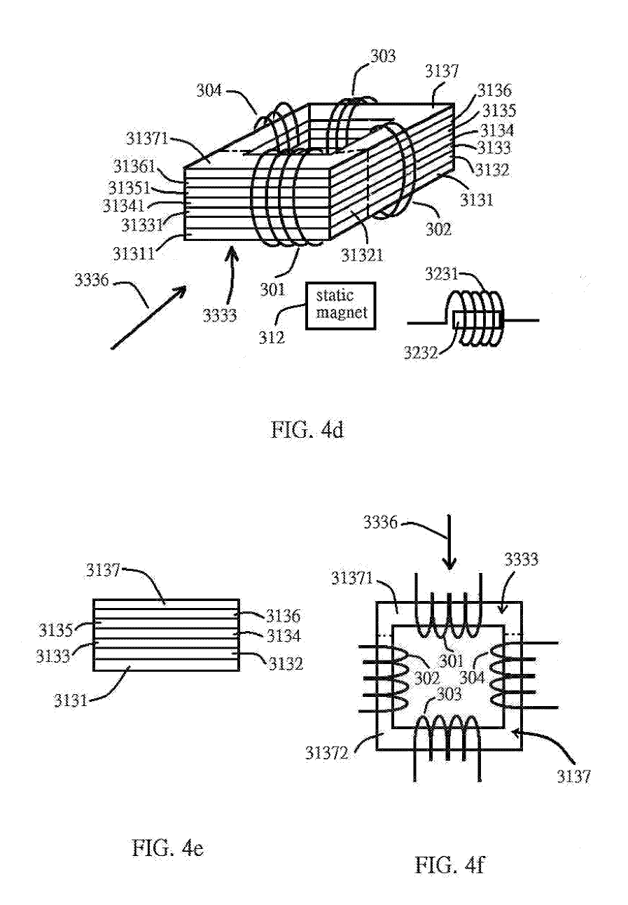

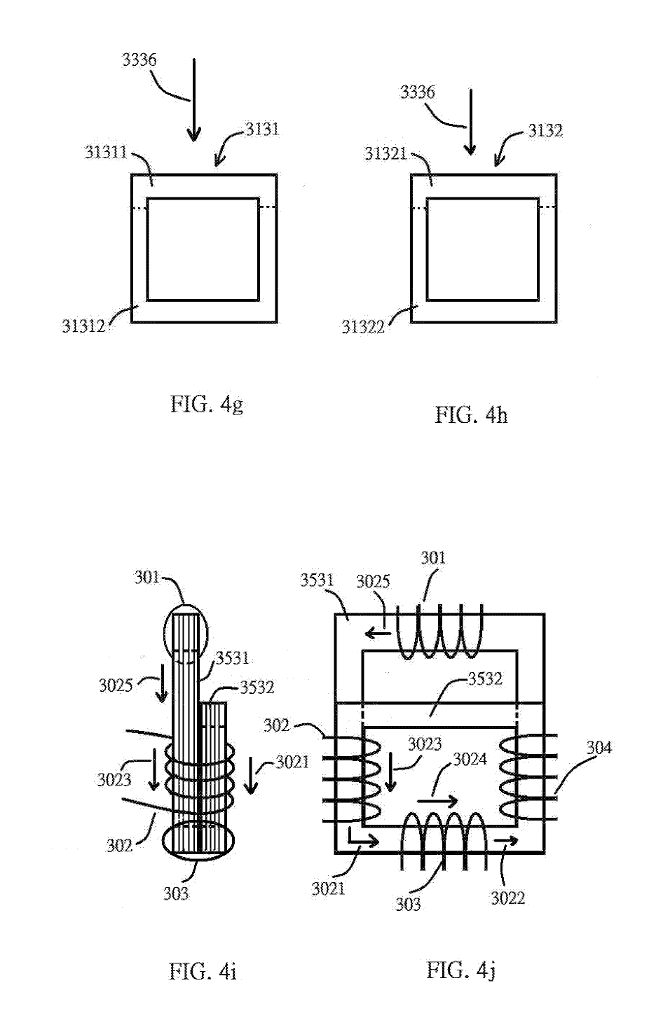

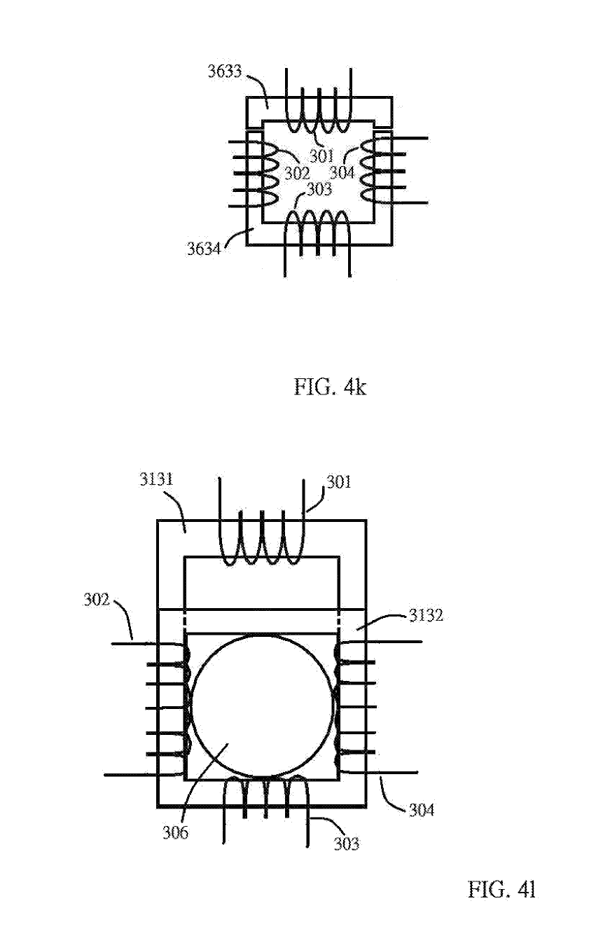

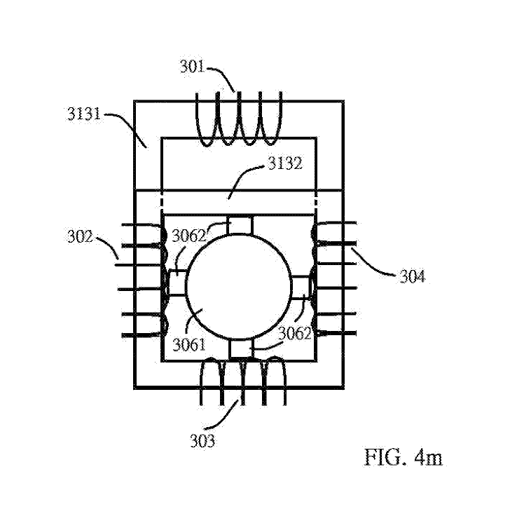

The cross section area of the magnetic conductor wound by coil also relates to the magnetic saturation level. A tenth embodiment of FIG. 4a has shown a magnetic conductor 371 having a thickness T and different cross section areas respectively wound by coil for receiving excitations. As seen in FIG. 4a, a first side wound by a first coil 3711 has a first width c1, a second side wound by a second coil 3712 has a second width c2, a third side wound by a third coil 3713 has a third width c3 and a fourth side wound by a fourth coil 3714 has a fourth width c4. Seen in FIG. 4a, c1 is the smallest among c2, c3 and c4 having the smallest cross section area. A smaller cross section area has a bigger magnetic flux density so that a smaller cross section area is easier saturated than a bigger cross section area by a same magnetization. In other words, a magnetic conductor can have different magnetic saturation level sections by defining different cross section areas in the magnetic core.

A magnetic conductor can be formed by different materials having different magnetic saturation levels from each other as shown in an eleventh embodiment of FIG. 4b. FIG. 4b has shown a top view of a magnetic conductor 381 formed by a first magnetic material 3811 having a first magnetic saturation level and a second magnetic material 3812 having a second magnetic saturation level divided by a dotted line in the magnetic conductor 381. The first magnetic saturation level is different from the second magnetic saturation level. According to the eleventh embodiment of FIG. 4b, different magnetic saturation level sections can be formed in a magnetic conductor by using different magnetic materials.

A magnetic conductor having different magnetic saturation level sections can be made of a magnetic material different portions of which can be under different annealing treatments. A twelfth embodiment, FIG. 4c has shown a top view of a magnetic conductor 382 formed by a magnetic material a portion of which 3821 is under a first annealing treatment and the other portion of which 3822 is under a second annealing treatment which is different from the first annealing treatment. Different annealing treatments on a same magnetic material can obtain different magnetic saturation levels. According to the twelfth embodiment of FIG. 4c, different magnetic saturation level sections can be formed in a magnetic conductor under different annealing treatments.

According to the embodiments of FIG. 4a, FIG. 4b and FIG. 4c, a magnetic conductor having different magnetic saturation level sections can be made of different magnetic materials having different magnetic saturation levels, a magnetic conductor having different magnetic saturation level sections can be made of a magnetic material different portions of which can be under different annealing treatments, or a magnetic conductor can have different magnetic satuartion level sections by defining different cross section areas. The term “different magnetic saturation level sections” formed in a magnetic conductor includes all the possibilities discussions above in the present invention.

Assuming the first magnetic core 313 of FIG. 3a, 3b or 3c is formed by seven magnetic conductor layers respectively as a first magnetic conductor 3131 as a bottom layer, a second magnetic conductor 3132, a third magnetic conductor 3133, a fourth magnetic conductor 3134, a fifth magnetic conductor 3135, a sixth magnetic conductor 3136 and a seventh magnetic conductor 3137 piled up by one magnetic conductor laying on another magnetic conductor as shown in a thirteen embodiment of FIG. 4d. The plurality of magnectic conductors of the seven-layer first magnetic core 313 can be electrically isolated with each other for having less eddy current problem.

A top view and a side view respectively of the first magnetic core 313 of the thirteen embodiment of FIG. 4d are respectively shown in FIG. 4f and FIG. 4e and a reference arrow 3336 shown in FIG. 4g, FIG. 4h, FIG. 4d and FIG. 4f are used to mark their reference orientations.

FIG. 4g has shown a top view of the first magnetic conductor 3131 of the seven-layer first magnetic core 313 having a first magnetic saturation level section 31311 and a second magnetic saturation level section 31312 separated by a dotted line.

A top view of the second magnetic conductor 3132 identical to the first magnetic conductor 3131 is shown in FIG. 4h.

The second magnetic conductor 3132 has a third magnetic saturation level section 31321 and a fourth magnetic saturation level section 31322 separated by a dotted line shown in FIG. 4h. Assuming the position of the third magnetic saturation level section 31321 relative to the fourth magnetic saturation level section 31322 of the second magnetic conductor 3132 of FIG. 4h is same to the position of the first magnetic saturation level section 31311 relative to the second magnetic saturation level section 31312 of the first magnetic conductor 3131 of FIG. 4g. The logic applies to the third magnetic conductor 3133, the fourth magnetic conductor 3134, the fifth magnetic conductor 3135, the sixth magnetic conductor 3136 and the seventh magnetic conductor 3137.

The third magnetic conductor 3133 has a fifth magnetic saturation level section 31331 and a sixth magnetic saturation level section 31332. The fourth magnetic conductor 3134 has a seventh magnetic saturation level section 31341 and an eighth magnetic saturation level section 31342. The fifth magnetic conductor 3135 has a nineth magnetic saturation level section 31351 and a tenth magnetic saturation level section 31352. The sixth magnetic conductor 3136 has an eleventh magnetic saturation level section 31361 and a twelfth magnetic saturation level section 31362. The seventh magnetic conductor 3137 has a thirteen magnetic saturation level section 31371 and a fourteenth magnetic saturation level section 31372.

For the purpose of avoiding duplication, a top view of the third magnetic conductor 3133, the fourth magnetic conductor 3134, the fifth magnetic conductor 3135, the sixth magnetic conductor 3136, and the seventh magnetic conductor 3137 are not drawn. It's noted again that different magnetic saturation level sections on each magnetic conductor can be formed by using different magnetic materials, under different annealing treatments or defining different cross section areas as respectively revealed by the tenth embodiment of FIG. 4a, the eleventh embodiment of FIG. 4b and the twelfth embodiment of FIG. 4c. The saturation levels of different magnetic saturation level sections on each magnetic conductor can be same or different.

FIG. 4e has shown the seven-layer magnetic core of FIG. 4d in side view formed by the first magnetic conductor 3131, the second magnetic conductor 3132, the third magnetic conductor 3133, the fourth magnetic conductor 3134, the fifth magnetic conductor 3135, the sixth magnetic conductor 3136, and the seventh magnetic conductor 3137 piled up with one magnetic conductor laying on another magnetic conductor. FIG. 4f has shown the seven-layer magnetic core of FIG. 4d in top view with the seventh magnetic conductor 3137 visible at the top.

The satuaration levels respectively of the first magnetic saturation section 31311 of the first magnetic conductor 3131, the third magnetic saturation section 31321 of the second magnetic conductor 3132, the fifth magnetic saturation section 31331 of the third magnetic conductor 3133, the seventh magnetic saturation section 31341 of the fourth magnetic conductor 3134, the nineth magnetic saturation section 31351 of the fifth magnetic conductor 3135, the eleventh magnetic saturation section 31361 of the sixth magnetic conductor 3136 and the thirteen magnetic saturation section 31371 of the seventh magnetic conductor 3137 can be different from each other or same so that they can be saturated one by one in a sequence.

For the purpose of convenience, a portion of the seven-layer first magnetic core of FIG. 4d formed by the first magnetic saturation level section 31311 of the first magnetic conductor 3131, the third magnetic saturation level section 31321 of the second magnetic conductor 3132, the fifth magnetic saturation level section 31331 of the third magnetic conductor 3133, the seventh magnetic saturation level section 31341 of the fourth magnetic conductor 3134, the nineth magnetic saturation level section 31351 of the fifth magnetic conductor 3135, the eleventh magnetic saturation level section 31361 of the sixth magnetic conductor 3136 and the thirteen magnetic saturation level section 31371 of the seventh magnetic conductor 3137 piled up together is called “a first magnetic saturation level portion” or simply “a first portion” marked by 3333.

A magnetic core can be formed by at least a magnetic conductor as revealed earlier above. According to the thirteen embodiment of FIG. 4d, different magnetic saturation level portions can be formed in a magnetic core formed by a plurality of magnetic conductors.

FIG. 4d has also shown the first coil 301 winding around the “first portion” 3333 of the first magnetic core 313 and the second coil 302, the third coil 303 and the fourth coil 304 winding around a second portion other than the “first portion” 3333 of the seven-layer first magnetic core 313.

The first portion 3333 of the first magnetic core of FIG. 4d can be saturated or partially saturated by a magnetization so that at a magnetic saturation or a partially saturation the inductance of the first coil 301 will become zero or smaller to less limit the current flowing through the first coil 301 in the switching circuit. The magnetization can be current from the electrical power source 309 flowing through the first coil 301, the static magnet 312 nearby, current flowing through the second coil 302 and the third coil 303, a magnetic field produced by current flowing through the inductive load 306 or a magnetic field produced by current flowing through the seventh coil 3231 winding around the third magnetic core 3232 nearby. According to the thirteen embodiment of FIG. 4d, at least a portion of the first magnetic core 313 wound by the first coil 301 can be saturated or partially saturated by current from the electrical power source 309 flowing through the first coil 301, the static magnet 312 nearby, current flowing through the second coil 302 and the third coil 303, a magnetic field produced by current flowing through the inductive load 306 or a magnetic field produced by current flowing through the seventh coil 3231 winding around the third magnetic core 3232 nearby.

The second portion other than the “first portion” 3333 of the seven-layer first magnetic core 313 of FIG. 4d wound by the second coil 302, the third coil 303 and the fourth coil 304 can be unsaturated, partially saturated or saturated by the magnetization above. The magnetization can be current from the electrical power source 309 flowing through the first coil 301, the static magnet 312 nearby, current flowing through the second coil 302 and the third coil 303, a magnetic field produced by current flowing through the inductive load 306 or a magnetic field produced by current flowing through the seventh coil 3231 winding around the third magnetic core 3232 nearby. It's noted that the second portion of the first magnetic core 313 other than the “the first portion” 3333 is unsaturated by the magnetization gaining better magnetic efficiency.

FIG. 4j has shown a fourteen embodiment of the first magnetic core 313 of FIG. 3a, 3b or 3c comprising a second magnetic core 3531 and a third magnetic core 3532 in top view magnetically coupling with the second magnetic core 3531 and FIG. 4i is the left side view of FIG. 4j. Both the second magnetic core 3531 and the third magnetic core 3532 respectively have a closed magnetic flux loop.

The first coil 301 winds on the second magnetic core 3531. The second coil 302, the third coil 303, and the fourth coil 304 respectively wind on both the second magnetic core 3531 and the third magnetic core 3532 as seen in FIG. 4i and FIG. 4j. A first magnetic flux and a second magnetic flux respectively induced by current flowing through the second coil 302 and the third coil 303 flowing through the third magnetic core 3532 should be in a same orientation.

A third magnetic flux and a fourth magnetic flux respectively induced by current flowing through the second coil 302 and the third coil 303 flowing through the second magnetic core 3531 should be in a same orientation with a fifth magnetic flux induced by current flowing through the first coil 301 flowing through the second magnetic core 3531 such that the wiring orientation respectively of the first coil 301, the second coil 302, and the third coil 303 should be taken care of. In this case, for the purpose of convenience, the first coil 301, the second coil 302, and the third coil 303 can be called “coil-wiring in phase” in the present invention. An example, an orientation of the first magnetic flux 3021, the second magnetic flux 3022, the third magnetic flux 3023, the fourth magnetic flux 3024 and the fifth magnetic flux 3025 are seen in FIG. 4i and FIG. 4j.

The second magnetic core 3531 wound by the first coil 301 is saturated or partially saturated by a magnetization so that the inductance of the first coil 301 winding on the second magnetic core 3531 becomes zero or smaller to less limit the current from the electrical power source 309 to flow through the first coil 301 and to avoid the first coil 301 becoming a significant second inductive load of the switching circuit. The magnetization can be current from the electrical power source 309 flowing through the first coil 301, the static magnet 312 nearby, current flowing through the second coil 302 and the third coil 303, a magnetic field produced by current flowing through the inductive load 306 or a magnetic field produced by current flowing through the seventh coil 3231 winding around the third magnetic core 3232 nearby.

The third magnetic core 3532 can be an unsaturable magnetic core, a partially saturable magnetic core, or a saturable magnetic core by the magnetization. The magnetization can be current from the electrical power source 309 flowing through the first coil 301, the static magnet 312 nearby, current flowing through the second coil 302 and the third coil 303, a magnetic field produced by current flowing through the inductive load 306 or a magnetic field produced by current flowing through the seventh coil 3231 winding around the third magnetic core 3232 nearby. The third magnetic core 3532 is unsaturated by the magnetization gaining better magnetic efficiency. The magnetic saturation levels of the second magnetic core 3531 and the third magnetic core 3532 can be different or same.

The fourteen embodiment of FIG. 4i and FIG. 4j advantages that both the second magnetic core 3531 and the third magnetic core 3532 respectively have a closed magnetic flux loop for having better magnetic efficiency.

A fifteen embodiment of the first magnetic core 313 of FIG. 3a, 3b or 3c is shown in FIG. 4k. FIG. 4k has shown the first magnetic core 313 of FIG. 3a, FIG. 3b or FIG. 3c comprises a second magnetic core 3633 and a third magnetic core 3634 in physical contact with the second magnetic core 3633 to form a closed magnetic flux loop between the second magnetic core 3633 and the third magnetic core 3634. The first coil 301 winds on the second magnetic core 3633. The second coil 302, the third coil 303, and the fourth coil 304 wind on the third magnetic core 3634. A magnetic flux respectively induced by current flowing through the first coil 301, the second coil 302 and the third coil 303 flowing through the closed magnetic flux loop formed by the second magnetic core 3633 and the third magnetic core 3634 should be in a same orientation for having better magnetic efficiency so that the first coil 301, the second coil 302, and the third coil 303 should be coil-wiring in phase.

The second magnetic core 3633 wound by the first coil 301 is saturated or partially saturated by a magnetization so that the inductance of the first coil 301 winding on the second magnetic core 3633 becomes zero or smaller to less limit the current from the electrical power source 309 to flow through the first coil 301 and avoid the first coil 301 becoming a significant second inductive load of the switching circuit. The magnetization can be current from the electrical power source 309 flowing through the first coil 301, the static magnet 312 nearby, current flowing through the second coil 302 and the third coil 303 winding on the third magnetic core 3634, or a magnetic field produced by current flowing through the seventh coil 3231 winding around the third magnetic core 3232 nearby.

The third magnetic core 3634 can be unsaturated, partially saturated or saturated by a magnetization. The magnetization can be current flowing through the second coil 302 and the third coil 303, current from the electrical power source 309 flowing through the first coil 301 winding on the second magnetic core 3633, the static magnet 312 nearby, or a magnetic field produced by current flowing through the seventh coil 3231 winding around the third magnetic core 3232 nearby. Obviously, the third magnetic core 3634 is unsaturated by the magnetization has better magnetic efficiency.

The shapes of the first magnetic core 3131 is not limited. The material made of the first magnetic core 3131 is not limited.

A magnetic field produced by current flowing through the inductive load 306 of the witching circuit of FIG. 3a, FIG. 3b or 3c can be in a magnetically interactive distance with the first magnetic core 313 as a magnetic compensation to the first magnetic core 313 to enhance the magnetic efficiency of the first magnetic core 313. As revealed earlier, the inductive load 306 is not limited, it can be an inductor, an electric motor, an electric generator, or a transformer.

For example, a sixteen embodiment as shown in FIG. 4l, the inductive load 306 can be disposed inside the third closed-loop magnetic core 3132 of the fourteen embodiment of FIG. 4j. A seventeen embodiment, the inductive load 306 of FIG. 4l can be an electric motor or an electric generator 3061 having salients 3062 toward outside as shown in FIG. 4m.

An energy discharge capacitor and an open circuit device or an open circuit device damper electrically connected in series is shown in embodiments of FIG. 2g, FIG. 2h, FIG. 2i and FIG. 2j.

FIG. 2g has shown a first energy discharge capacitor 21 that has a first electrode 211, a second electrode 212 and a dielectric 213 disposed between the first electrode 211 and the second electrode 212 and any one of the first electrode 211 and the second electrode 212 is a PDR device and the other one of the first electrode 211 and the second electrode 212 is a NDR device. FIG. 2g has also shown an open circuit device 20 that has a first terminal 201 and a second terminal 202 separating the first terminal 201 by an open gap 203. A side of any one of the first terminal 201 and the second terminal 202 of the open circuit device 20 is electrically connected to a side of any one of the first electrode 211 and the second electrode 212 of the first energy discharge capacitor 21.

Any one of the first terminal 201 and the second terminal 202 of the open circuit device 20 can be a PDR device and the other one of the first terminal 201 and the second terminal 202 of the open circuit device 20 is a NDR device. In this case, the open circuit device 20 becomes a first open circuit device damper. It's noted that an energy field 29 can be used to control the threshold voltage of the open circuit device 20 as revealed earlier in the embodiment of FIG. 2m.

FIG. 2h has shown an inductor 22 electrically connected to the first electrode 211 and the second electrode 212 of the first energy discharge capacitor 21 of FIG. 2g. The first energy discharge capacitor 21 and the inductor 22 form a second energy discharge capacitor.

FIG. 2i has shown a first conductive nanoscaled device 2811 and a second conductive nanoscaled device 2821 respectively electrically connect to the first terminal 201 and the second terminal 202 of the open circuit device of FIG. 2g. The first conductive nanoscaled device 2811 and the second conductive nanoscaled device 2821 are facing with each other for having electrical discharges between them. If the first terminal 201 and the second terminal 202 are conductors, then the open circuit device is a fourth open circuit device. If any one of the first terminal 201 and the second terminal 202 is a PDR device and the other one is a NDR device, then the open circuit device is a second open circuit device damper.

FIG. 2j has shown an inductor 22 electrically connected to the first electrode 211 and the second electrode 212 of the energy discharge capacitor 21 of FIG. 2i. The first energy discharge capacitor 21 and the inductor 22 form a second energy discharge capacitor.

FIG. 2k has shown an embodiment that the first terminal 201 and the second terminal 202 of the open circuit device 20 of FIG. 2i are respectively specified as a first PDR device and a first NDR device and the first electrode 211 and the second electrode 212 of the energy discharge capacitor 21 of FIG. 2i are respectively specified as a second PDR device and a second NDR device. FIG. 2l has shown an inductor 22 electrically connected to the first electrode 211 and the second electrode 212 of the energy discharge capacitor 21 of FIG. 2k.

The embodiments respectively of FIG. 2g, FIG. 2h, FIG. 2i, FIG. 2j, FIG. 2k and FIG. 2l can respectively be viewed as a damper having a controllable threshold voltage by an energy field. It's noted again that the energy field can be an electrical field, a magnetic field or a thermal field, etc. The embodiments respectively of FIG. 2g, FIG. 2i and FIG. 2k are respectively a damper for dissipating ac but the embodiments respectively of FIG. FIG. 2h, FIG. 2j and FIG. 2l are respectively a damper capable of dissipating ac and dc as revealed earlier in the embodiments of FIG. 2e and FIG. 2f.

1. An assembly, comprising:
a first magnetic core;
a switching circuit, comprising:
an electrical power source for providing dc;
a first coil winding around the first magnetic core;
an inductive load; and
a frequency modulator for providing frequency, wherein the electrical power source, the first coil, the inductive load, and the frequency modulator electrically connected in series with each other;
a first reaction circuit in parallel to the inductive load, comprising a second coil winding around the first magnetic core, an action/reaction isolation device, and a damper electrically connected in series with each other;
a second reaction circuit in parallel to the inductive load and the first reaction circuit, comprising a third coil winding around the first magnetic core, a first rectifier, and a buffer electrically connected in series with each in the sequence; and
a fourth coil winding on the first magnetic core for an amplified output.
wherein a Lenz electrical power induced by the switching circuit diverges flowing through the first reaction circuit and the second reaction circuit by bandwidth, a high frequency Lenz power goes through the first reaction circuit and low frequency Lenz power goes through the second reaction circuit.

2. The assembly of claim 1, wherein at least a portion of the first magnetic core wound by the first coil is saturated or partially saturated by current flowing through the first coil, a static magnet nearby, current flowing through the second coil and the third coil, or current flowing through the inductive load so that an inductance of the first coil winding around the first magnetic core becomes zero or smaller to less limit current from the electrical power source to flow through the first coil.

3. The assembly of claim 2, wherein the first magnetic core comprises a second magnetic core and a third magnetic core, the first coil winds around the second magnetic core and the second coil, the third coil, and the fourth coil wind around both the second magnetic core and the third magnetic core, the second magnetic core is saturated or partially saturated by current from the electrical power source flowing through the first coil, the static magnet nearby, current flowing the second coil and the third coil or current flowing through the inductive load.

4. The assembly of claim 2, wherein the first magnetic core comprises a second magnetic core and a third magnetic core forming a magnetically closed loop with the second magnetic core, the first coil winds around the second magnetic core and the second coil, the third coil, and the fourth coil wind around the third magnetic core, the second magnetic core is saturated or partially saturated by current from the electrical power source flowing through the first coil, the static magnet nearby, current flowing the second coil and the third coil or current flowing through the inductive load.

5. The assembly of claim 1, wherein the damper and the action/reaction isolation device in the first reaction circuit is selected from the group consisting of: a first open circuit device and a first energy discharge capacitor electrically connected in series, a second open circuit device and a first energy discharge capacitor electrically connected in series, a third open circuit device and a first energy discharge capacitor electrically connected in series, a fourth open circuit device and a first energy discharge capacitor electrically connected in series, a first open circuit device damper and a first energy discharge capacitor electrically connected in series, a second open circuit device damper and a first energy discharge capacitor electrically connected in series, a first open circuit device and a second energy discharge capacitor electrically connected in series, a second open circuit device and a second energy discharge capacitor electrically connected in series, a third open circuit device and a second energy discharge capacitor electrically connected in series, a fourth open circuit device and a second energy discharge capacitor electrically connected in series, a first open circuit device damper and a second energy discharge capacitor electrically connected in series, a second open circuit device damper and a second energy discharge capacitor electrically connected in series, a first open circuit device damper, a second open circuit device damper, a first energy discharge capacitor, a second energy discharge capacitor, a PDR device and a NDR device electrically connected in series and a diode electrically connecting to the PDR device and the NDR device, a PDR device and a NDR device electrically connected in series and a capacitor electrically connecting to the PDR device and the NDR device, a PDR device and a NDR device electrically connected in series and a first energy discharge capacitor electrically connecting to the PDR device and the NDR device, a PDR device and a NDR device electrically connected in series and a second energy discharge capacitor electrically connecting to the PDR device and the NDR device, a PDR device and a NDR device electrically connected in series and a first open circuit device electrically connecting to the PDR device and the NDR device, a PDR device and a NDR device electrically connected in series and a second open circuit device electrically connecting to the PDR device and the NDR device, a PDR device and a NDR device electrically connected in series and a third open circuit device electrically connecting to the PDR device and the NDR device, a PDR device and a NDR device electrically connected in series and a fourth open circuit device electrically connecting to the PDR device and the NDR device, a PDR device and a NDR device electrically connected in series and a first open circuit device damper electrically connecting to the PDR device and the NDR device, and a PDR device and a NDR device electrically connected in series and a second open circuit device damper electrically connecting to the PDR device and the NDR device; the buffer is selected from the group consisting of a capacitor, a battery, a superconductive coil and a flywheel; the inductive load 306 is selected from the group consisting of an inductor, an electric motor, an electric generator, and a transformer.

6. The assembly of claim 2, wherein the damper and the action/reaction isolation device in the first reaction circuit is selected from the group consisting of: a first open circuit device and a first energy discharge capacitor electrically connected in series, a second open circuit device and a first energy discharge capacitor electrically connected in series, a third open circuit device and a first energy discharge capacitor electrically connected in series, a fourth open circuit device and a first energy discharge capacitor electrically connected in series, a first open circuit device damper and a first energy discharge capacitor electrically connected in series, a second open circuit device damper and a first energy discharge capacitor electrically connected in series, a first open circuit device and a second energy discharge capacitor electrically connected in series, a second open circuit device and a second energy discharge capacitor electrically connected in series, a third open circuit device and a second energy discharge capacitor electrically connected in series, a fourth open circuit device and a second energy discharge capacitor electrically connected in series, a first open circuit device damper and a second energy discharge capacitor electrically connected in series, a second open circuit device damper and a second energy discharge capacitor electrically connected in series, a first open circuit device damper, a second open circuit device damper, a first energy discharge capacitor, a second energy discharge capacitor, a PDR device and a NDR device electrically connected in series and a diode electrically connecting to the PDR device and the NDR device, a PDR device and a NDR device electrically connected in series and a capacitor electrically connecting to the PDR device and the NDR device, a PDR device and a NDR device electrically connected in series and a first energy discharge capacitor electrically connecting to the PDR device and the NDR device, a PDR device and a NDR device electrically connected in series and a second energy discharge capacitor electrically connecting to the PDR device and the NDR device, a PDR device and a NDR device electrically connected in series and a first open circuit device electrically connecting to the PDR device and the NDR device, a PDR device and a NDR device electrically connected in series and a second open circuit device electrically connecting to the PDR device and the NDR device, a PDR device and a NDR device electrically connected in series and a third open circuit device electrically connecting to the PDR device and the NDR device, a PDR device and a NDR device electrically connected in series and a fourth open circuit device electrically connecting to the PDR device and the NDR device, a PDR device and a NDR device electrically connected in series and a first open circuit device damper electrically connecting to the PDR device and the NDR device, and a PDR device and a NDR device electrically connected in series and a second open circuit device damper electrically connecting to the PDR device and the NDR device; the buffer is selected from the group consisting of a capacitor, a battery, a superconductive coil and a flywheel; the inductive load 306 is selected from the group consisting of an inductor, an electric motor, an electric generator, and a transformer.

7. The assembly of claim 3, wherein the damper and the action/reaction isolation device in the first reaction circuit is selected from the group consisting of: a first open circuit device and a first energy discharge capacitor electrically connected in series, a second open circuit device and a first energy discharge capacitor electrically connected in series, a third open circuit device and a first energy discharge capacitor electrically connected in series, a fourth open circuit device and a first energy discharge capacitor electrically connected in series, a first open circuit device damper and a first energy discharge capacitor electrically connected in series, a second open circuit device damper and a first energy discharge capacitor electrically connected in series, a first open circuit device and a second energy discharge capacitor electrically connected in series, a second open circuit device and a second energy discharge capacitor electrically connected in series, a third open circuit device and a second energy discharge capacitor electrically connected in series, a fourth open circuit device and a second energy discharge capacitor electrically connected in series, a first open circuit device damper and a second energy discharge capacitor electrically connected in series, a second open circuit device damper and a second energy discharge capacitor electrically connected in series, a first open circuit device damper, a second open circuit device damper, a first energy discharge capacitor, a second energy discharge capacitor, a PDR device and a NDR device electrically connected in series and a diode electrically connecting to the PDR device and the NDR device, a PDR device and a NDR device electrically connected in series and a capacitor electrically connecting to the PDR device and the NDR device, a PDR device and a NDR device electrically connected in series and a first energy discharge capacitor electrically connecting to the PDR device and the NDR device, a PDR device and a NDR device electrically connected in series and a second energy discharge capacitor electrically connecting to the PDR device and the NDR device, a PDR device and a NDR device electrically connected in series and a first open circuit device electrically connecting to the PDR device and the NDR device, a PDR device and a NDR device electrically connected in series and a second open circuit device electrically connecting to the PDR device and the NDR device, a PDR device and a NDR device electrically connected in series and a third open circuit device electrically connecting to the PDR device and the NDR device, a PDR device and a NDR device electrically connected in series and a fourth open circuit device electrically connecting to the PDR device and the NDR device, a PDR device and a NDR device electrically connected in series and a first open circuit device damper electrically connecting to the PDR device and the NDR device, and a PDR device and a NDR device electrically connected in series and a second open circuit device damper electrically connecting to the PDR device and the NDR device; the buffer is selected from the group consisting of a capacitor, a battery, a superconductive coil and a flywheel; the inductive load 306 is selected from the group consisting of an inductor, an electric motor, an electric generator, and a transformer.

8. The assembly of claim 4, wherein the damper and the action/reaction isolation device in the first reaction circuit is selected from the group consisting of: a first open circuit device and a first energy discharge capacitor electrically connected in series, a second open circuit device and a first energy discharge capacitor electrically connected in series, a third open circuit device and a first energy discharge capacitor electrically connected in series, a fourth open circuit device and a first energy discharge capacitor electrically connected in series, a first open circuit device damper and a first energy discharge capacitor electrically connected in series, a second open circuit device damper and a first energy discharge capacitor electrically connected in series, a first open circuit device and a second energy discharge capacitor electrically connected in series, a second open circuit device and a second energy discharge capacitor electrically connected in series, a third open circuit device and a second energy discharge capacitor electrically connected in series, a fourth open circuit device and a second energy discharge capacitor electrically connected in series, a first open circuit device damper and a second energy discharge capacitor electrically connected in series, a second open circuit device damper and a second energy discharge capacitor electrically connected in series, a first open circuit device damper, a second open circuit device damper, a first energy discharge capacitor, a second energy discharge capacitor, a PDR device and a NDR device electrically connected in series and a diode electrically connecting to the PDR device and the NDR device, a PDR device and a NDR device electrically connected in series and a capacitor electrically connecting to the PDR device and the NDR device, a PDR device and a NDR device electrically connected in series and a first energy discharge capacitor electrically connecting to the PDR device and the NDR device, a PDR device and a NDR device electrically connected in series and a second energy discharge capacitor electrically connecting to the PDR device and the NDR device, a PDR device and a NDR device electrically connected in series and a first open circuit device electrically connecting to the PDR device and the NDR device, a PDR device and a NDR device electrically connected in series and a second open circuit device electrically connecting to the PDR device and the NDR device, a PDR device and a NDR device electrically connected in series and a third open circuit device electrically connecting to the PDR device and the NDR device, a PDR device and a NDR device electrically connected in series and a fourth open circuit device electrically connecting to the PDR device and the NDR device, a PDR device and a NDR device electrically connected in series and a first open circuit device damper electrically connecting to the PDR device and the NDR device, and a PDR device and a NDR device electrically connected in series and a second open circuit device damper electrically connecting to the PDR device and the NDR device; the buffer is selected from the group consisting of a capacitor, a battery, a superconductive coil and a flywheel; the inductive load 306 is selected from the group consisting of an inductor, an electric motor, an electric generator, and a transformer.

9. The assembly of claim 5, wherein an inductor of the second energy discharge capacitor is formed by a fourth magnetic core and a fifth coil winding around the second magnetic core, the fourth magnetic core is saturated or partially saturated by current flowing through the fifth coil, a static magnet nearby or a magnetic field produced by current flowing through the inductive load.

10. The assembly of claim 6, wherein an inductor of the second energy discharge capacitor is formed by a fourth magnetic core and a fifth coil winding around the second magnetic core, the fourth magnetic core is saturated or partially saturated by current flowing through the fifth coil, a static magnet nearby or a magnetic field produced by current flowing through the inductive load.

11. The assembly of claim 7, wherein an inductor of the second energy discharge capacitor is formed by a fourth magnetic core and a fifth coil winding around the second magnetic core, the fourth magnetic core is saturated or partially saturated by current flowing through the fifth coil, a static magnet nearby or a magnetic field produced by current flowing through the inductive load.

12. The assembly of claim 8, wherein an inductor of the second energy discharge capacitor is formed by a fourth magnetic core and a fifth coil winding around the second magnetic core, the fourth magnetic core is saturated or partially saturated by current flowing through the fifth coil, a static magnet nearby or a magnetic field produced by current flowing through the inductive load.

13. The assembly of claim 5, wherein a diameter of the second coil is smaller than that of the third coil, a number of coil turns of the second coil are fewer than that of the third coil, the PDR is a positive temperature coefficient (or PTC), the NDR is a metal oxided material or a negative temperature coefficient (or NTC), a conductive nanoscaled material of the third open device, the fourth open circuit device, or the second open circuit device damper is selected from the group consisting of a CNT, a graphene, a diamond-like carbon, and C₆₀ family.

14. The assembly of claim 6, wherein a diameter of the second coil is smaller than that of the third coil, a number of coil turns of the second coil are fewer than that of the third coil, the PDR is a positive temperature coefficient (or PTC), the NDR is a metal oxided material or a negative temperature coefficient (or NTC), a conductive nanoscaled material of the third open device, the fourth open circuit device, or the second open circuit device damper is selected from the group consisting of a CNT, a graphene, a diamond-like carbon, and C₆₀ family.

15. The assembly of claim 7, wherein a diameter of the second coil is smaller than that of the third coil, a number of coil turns of the second coil are fewer than that of the third coil, the PDR is a positive temperature coefficient (or PTC), the NDR is a metal oxided material or a negative temperature coefficient (or NTC), a conductive nanoscaled material of the third open device, the fourth open circuit device, or the second open circuit device damper is selected from the group consisting of a CNT, a graphene, a diamond-like carbon, and C₆₀ family.

16. The assembly of claim 8, wherein a diameter of the second coil is smaller than that of the third coil, a number of coil turns of the second coil are fewer than that of the third coil, the PDR is a positive temperature coefficient (or PTC), the NDR is a metal oxided material or a negative temperature coefficient (or NTC), a conductive nanoscaled material of the third open device, the fourth open circuit device, or the second open circuit device damper is selected from the group consisting of a CNT, a graphene, a diamond-like carbon, and C₆₀ family.

17. The assembly of claim 14, wherein each open circuit device and each open circuit device damper respectively have a threshold voltage and comprise a first terminal and a second terminal, an energy field applied on a medium in an energetically interactive distance with the first terminal and the second terminal to change the threshold voltage.

18. The assembly of claim 15, wherein each open circuit device and each open circuit device damper respectively have a threshold voltage and comprise a first terminal and a second terminal, an energy field applied on a medium in an energetically interactive distance with the first terminal and the second terminal to change the threshold voltage.

19. An assembly, comprising:
a first magnetic core;
a switching circuit, comprising:
an electrical power source;
a first coil winding around the first magnetic core;
an inductive load; and
a frequency modulator for providing frequency, wherein the electrical power source, the first coil, the inductive load, and the frequency modulator electrically connected in series with each other;
a reaction circuit in parallel to the inductive load of the switching circuit, comprising a second coil winding around the first magnetic core, an action/reaction isolation device, and a damper electrically connected in series with each other; and
a third coil winding on the first magnetic core for an output, wherein at least a portion of the first magnetic core wound by the first coil is saturated or partially saturated by current flowing through the first coil, a static magnet nearby, current flowing through the second coil and the third coil, or a magnetic field produced by current flowing through the inductive load.

20. The assembly of claim 19, wherein the damper and the action/reaction isolation device in the reaction circuit is selected from the group consisting of: a first open circuit device and a first energy discharge capacitor electrically connected in series, a second open circuit device and a first energy discharge capacitor electrically connected in series, a third open circuit device and a first energy discharge capacitor electrically connected in series, a fourth open circuit device and a first energy discharge capacitor electrically connected in series, a first open circuit device damper and a first energy discharge capacitor electrically connected in series, a second open circuit device damper and a first energy discharge capacitor electrically connected in series, a first open circuit device and a second energy discharge capacitor electrically connected in series, a second open circuit device and a second energy discharge capacitor electrically connected in series, a third open circuit device and a second energy discharge capacitor electrically connected in series, a fourth open circuit device and a second energy discharge capacitor electrically connected in series, a first open circuit device damper and a second energy discharge capacitor electrically connected in series, a second open circuit device damper and a second energy discharge capacitor electrically connected in series, a first open circuit device damper, a second open circuit device damper, a first energy discharge capacitor, a second energy discharge capacitor, a PDR device and a NDR device electrically connected in series and a diode electrically connecting to the PDR device and the NDR device, a PDR device and a NDR device electrically connected in series and a capacitor electrically connecting to the PDR device and the NDR device, a PDR device and a NDR device electrically connected in series and a first energy discharge capacitor electrically connecting to the PDR device and the NDR device, a PDR device and a NDR device electrically connected in series and a second energy discharge capacitor electrically connecting to the PDR device and the NDR device, a PDR device and a NDR device electrically connected in series and a first open circuit device electrically connecting to the PDR device and the NDR device, a PDR device and a NDR device electrically connected in series and a second open circuit device electrically connecting to the PDR device and the NDR device, a PDR device and a NDR device electrically connected in series and a third open circuit device electrically connecting to the PDR device and the NDR device, a PDR device and a NDR device electrically connected in series and a fourth open circuit device electrically connecting to the PDR device and the NDR device, a PDR device and a NDR device electrically connected in series and a first open circuit device damper electrically connecting to the PDR device and the NDR device, and a PDR device and a NDR device electrically connected in series and a second open circuit device damper electrically connecting to the PDR device and the NDR device; the buffer is selected from the group consisting of a capacitor, a battery, a superconductive coil and a flywheel; the inductive load 306 is selected from the group consisting of an inductor, an electric motor, an electric generator, and a transformer.

21. The assembly of claim 20, wherein a diameter of the second coil is smaller than that of the third coil, a number of coil turns of the second coil are fewer than that of the third coil, the PDR is a positive temperature coefficient (or PTC), the NDR is a metal oxided material or a negative temperature coefficient (or NTC), a conductive nanoscaled material of the third open device, the fourth open circuit device, or the second open circuit device damper is selected from the group consisting of a CNT, a graphene, a diamond-like carbon, and C₆₀ family.

22. A power regenerator comprises a switching circuit and a first magnetic core, the switching circuit comprises at least a reaction circuit, a dc electrical power source, a first coil functioning as an EMI low pass filter, an inductive load and a frequency modulator, the dc electrical power source, the first coil, the inductive load and the frequency modulator are electrically connected in series with each other, the reaction circuit is in parallel with the inductive load comprises a second coil, a damper and an action/reaction isolation device electrically connected in series with each other, the second coil winds around the first magnetic core, Lenz electrical power produced by the switching circuit flowing through the second coil provides ac input to the first magnetic core, characterized in that the first coil winds on the first magnetic core, a dc current from the dc electrical power source flowing through the first coil provides a dc input to the first magnetic core, current flowing through the first coil and the second coil form a magnetic amplifier and its output is taken at a third coil winds around the first magnetic core, at least a portion of the first magnetic core wound by the first coil is saturated or partially saturated by current flowing through the first coil, current flowing the second coil, a static magnet nearby, current flowing through the inductive load or a magnetic field produced by current flowing through a second magnetic core nearby so that an inductance of the first coil winding on the first magnetic core becomes zero or smaller to less limit current from the dc electrical power source to flow through the first coil.
